(19) United States
(12) Patent Application Publication
(10) Pub. No.: US 2002/0171895 A1
(43) Pub. Date: Nov. 21, 2002

(54) Automatic ranging in a passive optical network

(75) Inventor: Tsung-Shien Chang, San-Wan Shin (TW)

Correspondence Address: Ya-Chiao Chang, 9 South Wickom Drive, Westfield, NJ, 07090, US

(73) Assignee: Glory Telecommunications Co., Ltd., Taoyuan (TW)

(21) Appl. No.: 09/842,294

(22) Filed: Apr. 25, 2001

(51) Int. Cl. H04J 14/08; H04B 10/00

(52) U.S. Cl. 359/168; 359/135

(57) ABSTRACT

The invention advantageously provides automatic ranging in a passive optical network or PON. A PON with automatic ranging according to the invention comprises an optical line terminal (OLT) connected to a plurality of optical network units (ONUs), a new ONU to be connected to the OLT, and at least one OLT frame sent from the OLT to the ONUs. The OLT frame according to the invention further comprises an OLT preamble alerting a particular ONU of the plurality of ONUs of the OLT frame, an OLT start frame delimiter (SFD) indicating a start of the OLT frame, an OLT header identifying the OLT, an OLT ranging time stamp sending a ranging time clock to one of the ONUs, an OLT churning control for a churning function of the PON, an ONU number instructing the particular ONU to respond to the OLT with a ranging time stamp and a churning key, and an OLT end frame delimiter (EFD) indicating an end of the OLT frame. Upon receipt of the OLT frame from the OLT by the particular ONU of the plurality of ONUs, an ONU frame is sent back to the OLT. The ONU frame according to the invention further comprises an ONU preamble alerting the OLT of the ONU frame, an ONU start frame delimiter (SFD) indicating a start of the ONU frame, an ONU header identifying the particular ONU, an ONU ranging time stamp responding to the ONU number, an ONU churning key responding to the ONU number, and an ONU end frame delimiter (EFD) indicating an end of the ONU frame. The ONU number in the ONU frame according to the invention further comprises an ONU number preamble alerting the particular ONU of the ONU number, a start sub-frame delimiter (SSD) indicating a start of the ONU number, an ONU ID identifying the particular ONU, an automatic bandwidth adjustment beginning (ABAB), and an automatic bandwidth adjustment terminating (ABAT). With the automatic ranging method and system according to the invention, a PON can advantageously maintain its operation without serious interruption as ONUs are added or removed from the PON. Furthermore, the safety guard time between consecutive data frames in the upstream or downstream transmission is advantageously and appropriately calculated as ONUs are added to or removed from the PON in accordance with the invention.

### RELATED APPLICATIONS

The present application relates to U.S. patent application Ser. No. 09/792,309 filed on Feb. 23, 2001 and entitled “IP PACKETIZED FRAME FORMAT IN A PASSIVE OPTICAL NETWORK” which is incorporated herein by reference.

### BACKGROUND OF THE INVENTION

1. Field of the Invention

The invention relates to optical networks and, more particularly, to the automatic ranging of optical network units (ONUs) in a passive optical network or PON and the adding or removing of ONUs from the PON.

2. Description of the Related Art

A passive optical network or PON is an optical network that does not employ, or reduces the use of, active devices such as lasers, regenerators and amplifiers. A PON includes an optical line terminal (OLT), located at the central office (CO) or cable headend, connected to a plurality of optical network units (ONUs). Because of the reduction in the number of active devices, the optical network can improve performance and become more cost-effective in operation and maintenance.

A PON can employ a tree, bus or ring architecture in connecting the single OLT with the ONUs. FIG. 1 is a block diagram generally illustrating a PON with an OLT 11 connected to a plurality of ONUs in a ring structure, including at least ONUs 111, 112, 113 and 114. FIG. 2 is a block diagram generally illustrating a PON with an OLT 21 connected to a plurality of ONUs in a tree architecture, including at least ONUs 211, 212, 213 and 214. FIG. 3 is a block diagram generally illustrating a PON with an OLT 31 connected to a plurality of ONUs in another tree architecture, including at least ONUs 311, 312, 313 and 314. Data travels upstream when the data are transmitted from the ONUs to the OLT. Data travels downstream when the data are transmitted from the OLT to the ONUs. The OLT can also be connected to another optical or non-optical network, e.g., the Internet or an Internet protocol (IP) network. Note that IP is a widely used protocol in the art that specifies the format of packets (also called datagrams in IP network) and the associated addressing scheme. A packet is a piece of a message transmitted over a packet-switching network (such as an IP network) where the packet includes the destination address in addition to the data, and each packet in the network is transmitted individually (which can follow different routes) to its corresponding destination.

For a service provider serving a plurality of end users with multiple ONUs, maintaining the PON without degradation in data transmission performance and service quality is critical as end users start or cancel subscription to the PON. There is therefore a general need in the art for a PON that allows automatic ranging and the smooth addition or removal of an ONU without serious interruption in the operation of the PON.

The addition or removal of one or more ONUs from a PON may also create problems in the transmission of data frames in the upstream or the downstream. For instance, the safety guard time between two consecutive data frames may be too close to too much for the smooth transmission therefore. Thus, there is a further need in the art for a method and system for appropriately calculating the safety guard time between consecutive data frames in transmission as ONUs are added to or removed from aPON.

### SUMMARY OF THE INVENTION

The invention advantageously provides automatic ranging in a passive optical network or PON. A PON with automatic ranging according to the invention comprises an optical line terminal (OLT) connected to a plurality of optical network units (ONUs), a new ONU to be connected to the OLT, and at least one OLT frame sent from the OLT to the ONUs. The OLT frame according to the invention further comprises an OLT preamble alerting a particular ONU of the plurality of ONUs of the OLT frame, an OLT start frame delimiter (SFD) indicating a start of the OLT frame, an OLT header identifying the OLT, an OLT ranging time stamp sending a ranging time clock to one of the ONUs, an OLT churning control for a churning function of the PON, an ONU number instructing the particular ONU to respond to the OLT with a ranging time stamp and a churning key, and an OLT end frame delimiter (EFD) indicating an end of the OLT frame. Upon receipt of the OLT frame from the OLT by the particular ONU of the plurality of ONUs, an ONU frame is sent back to the OLT. The ONU frame according to the invention further comprises an ONU preamble alerting the OLT of the ONU frame, an ONU start frame delimiter (SFD) indicating a start of the ONU frame, an ONU header identifying the particular ONU, an ONU ranging time stamp responding to the ONU number, an ONU churning key responding to the ONU number, and an ONU end frame delimiter (EFD) indicating an end of the ONU frame. The ONU number in the ONU frame according to the invention further comprises an ONU number preamble alerting the particular ONU of the ONU number, a start sub-frame delimiter (SSD) indicating a start of the ONU number, an ONU ID identifying the particular ONU, an automatic bandwidth adjustment beginning (ABAB), and an automatic bandwidth adjustment terminating (ABAT).

The invention also provides an automatic ranging method for the PON described herein. Using the automatic ranging method according to the invention, the PON can determine the safety guard time between two consecutive ONUs and allow the insertion or removal of an ONU into or from the PON without seriously interrupting the operation thereof. The automatic ranging method in accordance with the invention is herein illustrated and described for use in a tree-type PON in the present embodiment. It is nonetheless suitable for any type of PON networking structure in the art.

As a new ONU is to be inserted into the PON having a plurality of ONUs connected to an OLT of the PON, it is determined whether the PON is a cold PON. A cold PON is one with an OLT that has just been powered on and the ONUs connected therewith are already powered. If the ONUs are powered on after the OLT, then the PON is not a cold PON, but a warm PON with cold ONUs.

If it is determined that the PON is not a warm PON with cold ONUs, then the control flow is ended. The PON is a warm PON with cold ONUs if the PON is in service when there is one or more ONUs to be inserted into the PON.

The ONU ID is input into the OLT frame. The OLT frame is respectively sent to the ONUs in requesting the ranging time stamp and the churning key. The ONUs respectively return the ONU frame in response to the OLT frame from the OLT. An ONU returns the ONU frame in response as soon as it recognizes the value of ABAB of 00,00.

The round trip time for the OLT 100 to reach the ONUs is accordingly calculated. For example, as the OLT receives the returning ONU frame as its DW count reaches 012D and ends at 0133, then the round trip time between the OLT and the ONU (from which the ONU frame is sent) is 012D minus 0000 which equals 012D DW. The one-way trip time from this particular ONU to the OLT is thus 0096 DW.

It is determined whether there is a need for automatic ranging for further ONUs (i.e., whether another ONU is to be inserted or added into the PON). This determination is made since the automatic ranging according to the invention is performed for one ONU at a time for insertion into or removal from the PON. If it is determined in step 2409 that no further automatic ranging is needed for other ONUs, then the transmission sequence for the ONUs is arranged. The OLT by now has calculated the round trip time of for the ONUs. The one-way trip time for each of the ONUs is accordingly calculated. The OLT arranges the transmission sequence for the ONUs according to the arrived time from the least to the longest (i.e., from the nearest to the farthest).

The time difference between consecutive ONUs in the transmission sequence is calculated. The time difference between consecutive ONUs is masked and yields a corresponding masking result. It is determined whether the masking result is greater than a predetermined value. If it is determined in step 2417 that the masking result is not greater than the predetermined value, then a time difference value is set to the predetermined value. If it is determined that the masking result is greater than the predetermined value, then the time difference value is set to the difference of the predetermined value and the masking result. The ABAB and ABAT are accordingly recalculated. The recalculations are input into the OLT frame which is then resent to the ONUs. As the OLT frame is resent to the ONUs, the ranging time stamp and the churning key with different ABAB and ABAT values are requested. The ABAB instructs the ONUs to start transmission when its DW count reaches the same value as the ABAB. The ABAT instructs the ONUs when to stop transmission when its DW count reaches the same value as the ABAT. The DW count for the ONUs resets to 0000 when the respective ONU receives and recognizes the start frame delimiter (SFD) from the OLT.

Each of the ONUs returns a corresponding ONU frame to the OLT, sequentially responding to the OLT with its respective ONU ID. The arrived time for the ONUs is recalculated. The OLT records the values of the DW count at the beginning and end time when each data packet or frame is arrived at the OLT. The OLT ensures that the ONU frames are received correctly and error-free. The DW count values facilitate the OLT in ensuring that each ONU frame arrives in the proper transmission sequence. The arrived time is accordingly recalculated. The time difference between consecutive ONUs is recalculated.

It is determined whether the safety guard time is sufficient. The time difference between each two consecutive ONUs must be greater than or equal to a predetermined safety guard time, e.g., 0030. If it is determined that the safety guard time is insufficient, then the process steps according to the invention are repeated. If it is determined that the safety guard time is sufficient, then the control flow ends.

In the case of automatic ranging for a warm PON with cold ONUs according to the invention, transmission of data packets or frames of lower priority is stopped. For an already busy PON, the OLT instructs the ONUs to temporarily suspend transmission of lower-priority data packets or frames for a few mini-seconds.

The offset value for the ABAB is reset. A parameter is input regarding the distance between the OLT and the ONU to be inserted or removed (e.g., the new ONU). The parameter is used to determine the safety bandwidth margin for the ABAB in preventing the collision of data packets or frames.

The ABAB and ABAT are rearranged. The OLT rearranges the ABAB and ABAT for each ONU with an offset value (e.g., 3500 in hexadecimal) for the ONUs already in service with the PON and inserts the automatic ranging measurement packet or frame of the new ONU into the OLT frame.

The OLT waits for a proper time interval and then sends the OLT frame with new ABAB and ABAT to the ONUs which instructs each ONU to transmit ONU frames in a newly rearranged sequence. Each of the ONUs, upon receiving the OLT frame, returns an ONU frame as soon as it recognizes the value of the ABAB as 0000 (in hexadecimal).

The round trip time for the new ONU inserted into the PON (e.g., the new ONU) is calculated, e.g., at 0140. A new transmission sequence for the ONUs is rearranged. The time difference between consecutive ONUs is calculated. The time difference is masked and yields a masking result. If it is determined that the masking result is not greater than the predetermined value, then a time difference value is set to the predetermined value. If it is determined that the masking result is greater than the predetermined value, then the time difference value is set to the difference of the predetermined value and the masking result.

The ABAB and ABAT are accordingly recalculated. The ABAB and ABAT for each of the ONUs are calculated according to the time difference values calculated for each grouping of two consecutive data frames in transmission from the ONUs to the OLT in the PON. The recalculations are input into the OLT frame which is then resent to the ONUs. As the OLT frame is resent to the ONUs, the ranging time stamp and the churning key with different ABAB and ABAT values are requested. The ABAB instructs the ONUs to start transmission when its DW count reaches the same value as the ABAB. The ABAT instructs the ONUs when to stop transmission when its DW count reaches the same value as the ABAT. The OLT sends the OLT frame with the newly calculated ABAB and ABAT to instruct the ONUs to transmit data packets or frames in a new transmission sequence.

Each of the ONUs returns a corresponding ONU frame to the OLT, sequentially responding to the OLT with its respective ONU ID. The arrived time for the ONUs is recalculated. The OLT records the values of the DW count at the beginning and end time when each data packet or frame is arrived at the OLT. The DW count values facilitate the OLT in ensuring that each ONU frame arrives in the proper transmission sequence. The arrived time is accordingly recalculated. The time difference between consecutive ONUs is recalculated.

It is determined whether the safety guard time is sufficient. The time difference between each two consecutive ONUs must be greater than or equal to a predetermined safety guard time, e.g., 0030. If it is determined that the safety guard time is insufficient, then the process steps according to the invention are repeated. If it is determined that the safety guard time is sufficient, then the control flow ends.

With the automatic ranging method and system according to the invention, a PON can advantageously maintain its operation without serious interruption as ONUs are added or removed from the PON. Furthermore, the safety guard time between consecutive data frames in the upstream or downstream transmission is advantageously and appropriately calculated as ONUs are added to or removed from the PON in accordance with the invention.

### BRIEF DESCRIPTION OF THE DRAWINGS

The foregoing and other advantages and features of the invention will become more apparent from the detailed description of the preferred embodiments of the invention given below with reference to the accompanying drawings, not necessarily drawn to scale, in which:

FIG. 1 is a diagram generally illustrating a passive optical network (PON) in the art with a ring architecture;

FIG. 2 is a diagram generally illustrating a passive optical network (PON) in the art with a tree architecture;

FIG. 3 is a diagram generally illustrating a passive optical network (PON) in the art with another tree architecture;

FIG. 4 is a diagram generally illustrating the addition of an optical network unit (ONU) to the PON according to the invention;

FIG. 5 is a diagram illustrating an exemplary optical line terminal (OLT) frame in the automatic ranging according to the invention;

FIG. 6 is a diagram illustrating an exemplary OLT header in an OLT frame in the automatic ranging according to the invention;

FIG. 7 is a diagram illustrating an exemplary ONU number field in the OLT frame in the automatic ranging according to the invention;

FIG. 8 is a diagram illustrating an exemplary ONU frame in the automatic ranging according to the invention;

FIG. 9 is a diagram illustrating an exemplary ONU header in an ONU frame in the automatic ranging according to the invention;

FIG. 10 is a diagram illustrating an exemplary operation of an OLT frame in the automatic ranging according to the invention in a PON with a cold OLT;

FIG. 11 is a diagram illustrating an exemplary operation of an ONU frame in the automatic ranging according to the invention in a PON with a cold OLT;

FIG. 12 is an exemplary tabulation of the round-trip time and the one-way trip time calculated for each ONU with respect to the OLT in a PON in an empirical embodiment for the automatic ranging according to the invention;

FIG. 13 is a diagram illustrating data frames in transmission from the ONUs to the OLT in a PON;

FIG. 14 is a diagram illustrating the data frames in transmission from the ONUs to the OLT of a PON in the automatic ranging according to the invention;

FIG. 15 is an exemplary tabulation illustrating the operation of automatic ranging according to the invention with respect to the safety guard time between two consecutive data frames in transmission from the ONUs to the OLT in a PON;

FIG. 16 is a diagram illustrating an exemplary operation of an OLT frame in the automatic ranging according to the invention taking into account the calculated time difference values for each grouping of two consecutive data frames in transmission from the ONUs to the OLT in a PON;

FIG. 17 is an exemplary tabulation of the begin time and end time for each of the ONUs with respect to their arrival time at the OLT of a PON in the automatic ranging according to the invention;

FIG. 18 is another exemplary tabulation illustrating the operation of automatic ranging according to the invention with respect to the automatic bandwidth adjustment beginning (ABAB), automatic bandwidth adjustment terminating (ABAT) and the time difference between two consecutive data frames in transmission from the ONUs to the OLT in a PON;

FIG. 19 is a further exemplary tabulation illustrating the operation of automatic ranging according to the invention with respect to the automatic bandwidth adjustment beginning (ABAB) and the automatic bandwidth adjustment terminating (ABAT) with respect to consecutive data frames in transmission from the ONUs to the OLT in a PON;

FIG. 20 is a diagram illustrating the data frames in transmission from the ONUs (including a newly inserted ONU) to the OLT of a PON in the automatic ranging according to the invention;

FIG. 21 is a diagram illustrating an exemplary downstream data frame as a cold ONU is being inserted into a PON in the automatic ranging according to the invention;

FIG. 22 is an exemplary tabulation illustrating the operation of automatic ranging according to the invention with respect to the safety guard time between two consecutive data frames in transmission from the ONUs to the OLT as a cold ONU is being inserted into a PON;

FIG. 23 is a diagram illustrating an exemplary downstream data frame after an ONU is properly inserted into a PON in the automatic ranging according to the invention;

FIGS. 24 and 25 are flow diagrams illustrating a particular embodiment of the automatic ranging method in a PON according to the invention;

FIG. 26 is another diagram illustrating an exemplary downstream data frame after an ONU is properly inserted into a PON in the automatic ranging according to the invention; and

FIG. 27 is yet another exemplary tabulation illustrating the operation of automatic ranging according to the invention with respect to the automatic bandwidth adjustment beginning (ABAB), automatic bandwidth adjustment terminating (ABAT) and the time difference between two consecutive data frames in transmission from the ONUs to the OLT in a PON.

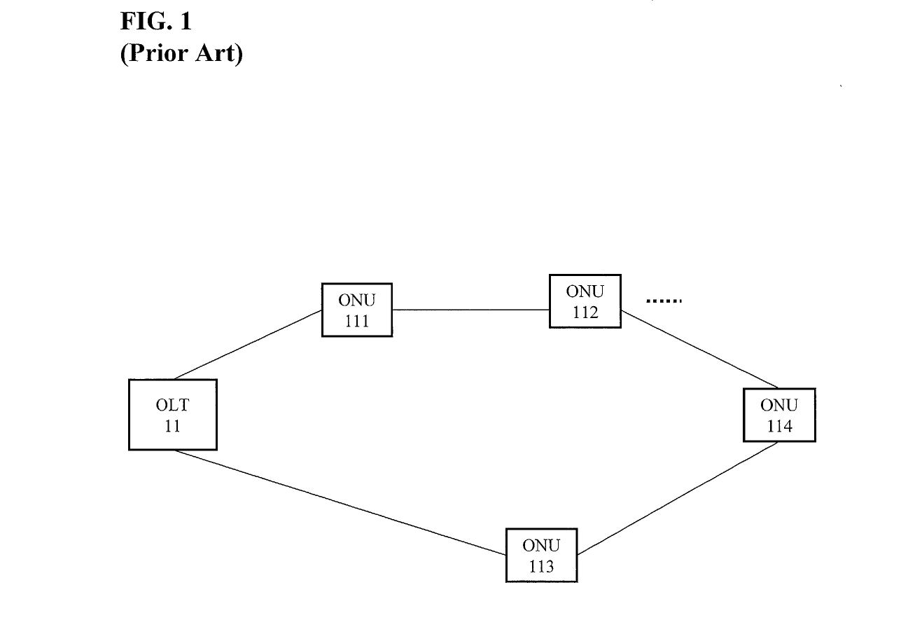

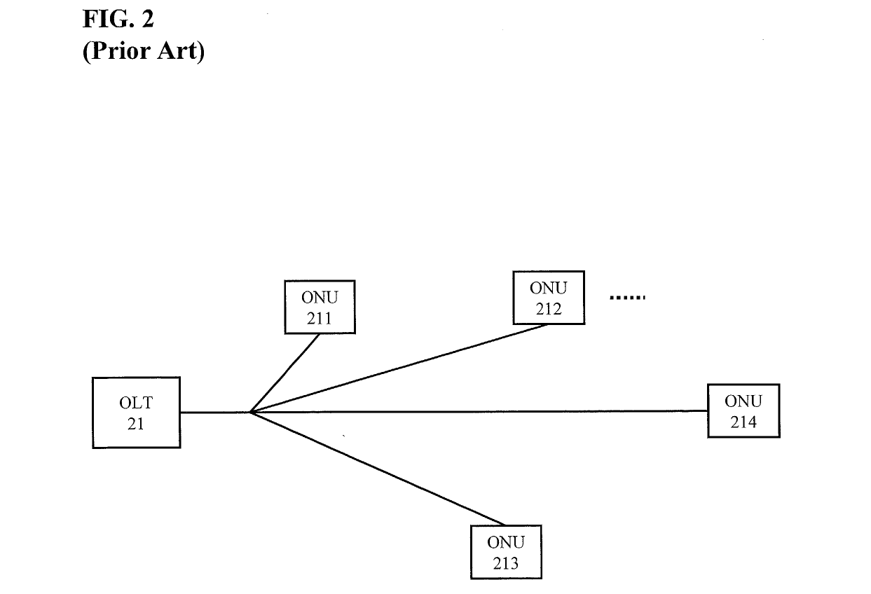

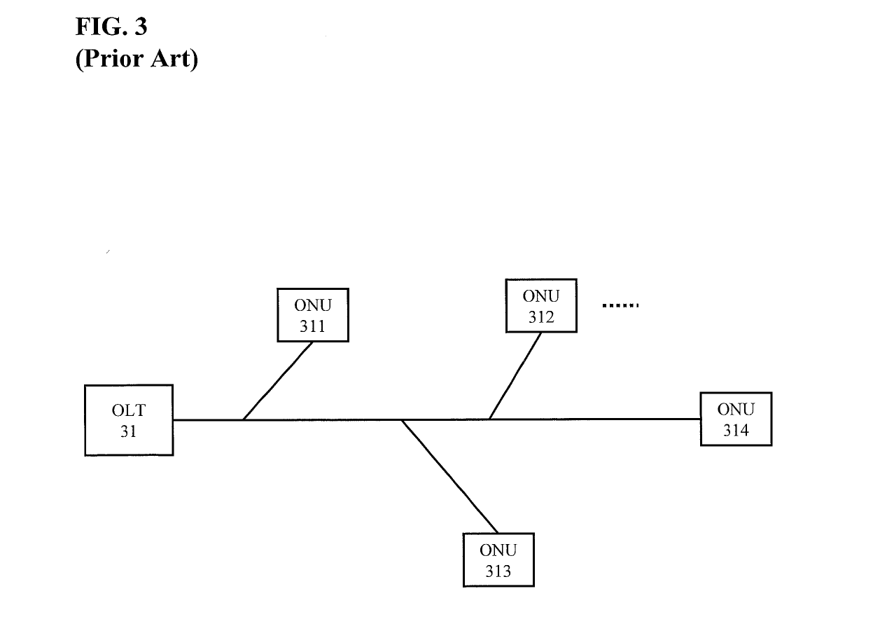

### DETAILED DESCRIPTION OF THE PREFERRED EMBODIMENTS

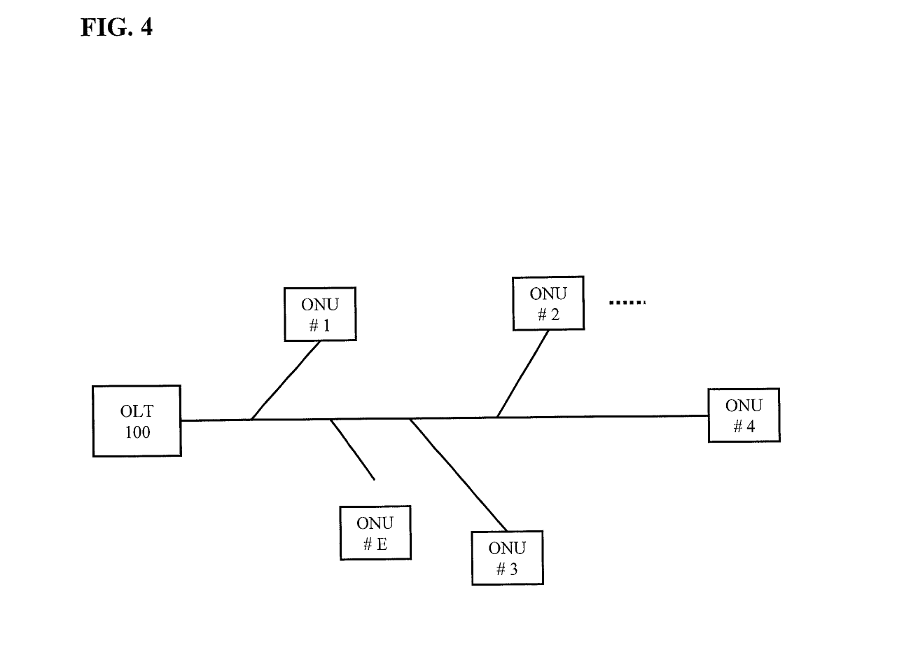

FIG. 4 is a block diagram that generally illustrates the addition of an optical network unit (ONU) into a passive optical network (PON) in accordance with the invention. The optical line terminal (OLT) 100 is connected to a plurality of ONUs, including at least the ONUs 1, 2, 3, and 4. The ONU E is to be added to the PON. The addition of the ONU E is illustrated in FIG. 4 with a PON of a tree architecture. The method and system according to the invention are not limited to a PON with a tree architecture, and can nonetheless be used in a PON with any type of architecture in general, including the ring- and bus-type architectures. The invention is herein described in conjunction with the PON shown in FIG. 4. Note that the invention can also be used in conjunction with the PON described in the related U.S. patent application Ser. No. 09/792,309 filed on Feb. 23, 2001 and entitled “IP PACKETIZED FRAME FORMAT IN A PASSIVE OPTICAL NETWORK” which is incorporated herein by reference.

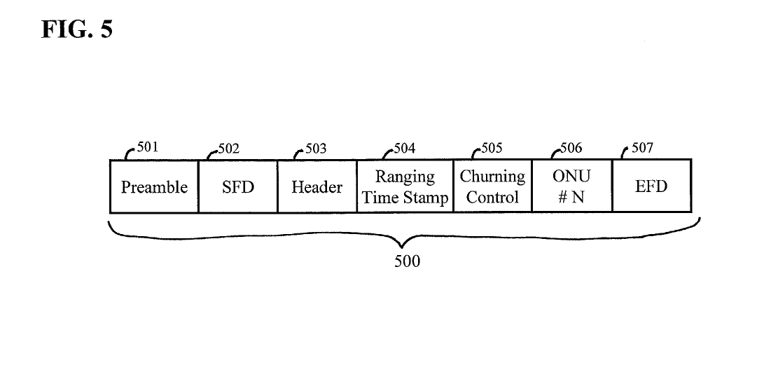

FIG. 5 is a diagram illustrating an exemplary OLT frame 500 in the automatic ranging according to the invention. The OLT frame 500 is sent from the OLT 100 to the ONUs (e.g., ONU 1) for calculating the safety guard time between two consecutive data frames in transmission. According to an exemplary embodiment of the invention, the OLT frame 500 comprises seven fields, including an OLT preamble 501, an OLT start frame delimiter (SFD) 502, an OLT header 503, an OLT ranging time stamp 504, an OLT churning control 505, an ONU number 506 and an OLT end frame delimiter (EFD) 507.

In the automatic ranging according to the invention, the safety guard time is calculated on a double-word (DW), or 32-bit, basis, i.e., the safety guard time between two consecutive ONUs is calculated in the number of DWs.

In accordance with the invention, the OLT preamble 501 contains 8 bytes (64 bits) of alternating 1s and 0s (AA, AA, AA, AA, AA, AA, AA, AA in hexadecimal) that alert the ONUs to the coming OLT frame 500 and enables the synchronization of its timing. The OLT SFD 502, at 4 bytes, is used as a frame alignment signal to indicate the start of the OLT frame 500.

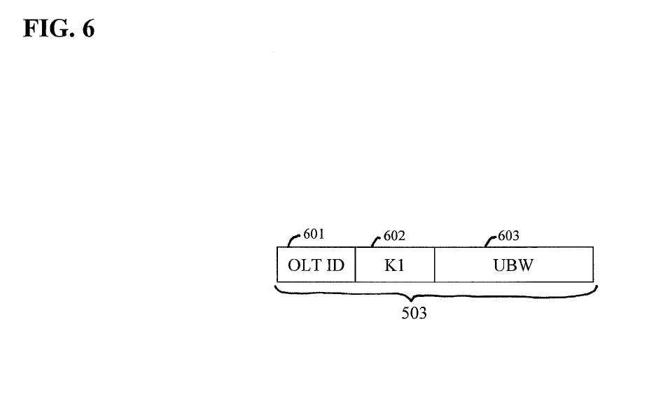

FIG. 6 is a diagram illustrating an exemplary OLT header 503 in an OLT frame 500 in the automatic ranging according to the invention. The OLT header 503 is used for the system control of the PON that identifies the OLT from which the data are being transmitted and specifies the unused bandwidth available for the PON. The OLT header 503 contains three fields, including an OLT identifier 601, at 1 byte, that indicates the OLT number on the PON (i.e., OLT 100), another byte K1 (602) used for the protection switch function for the PON, and an unused bandwidth UBW 603, at 2 bytes, for the automatic bandwidth adjustment function in the PON.

Referring again to FIG. 5, the OLT ranging time stamp 504 (4 bytes) is used to send the ranging time clock to the ONUs (e.g., ONU 1). The ONU 1, for example, copies the ranging time clock received from the OLT 100 and stores it into the OLT ranging time stamp 504 for the ONU 1. In accordance with the invention, the OLT 1100 calculates the timing difference (i.e., the round trip time) between the receiving time, the ranging time stamp received from the ONU 1, and the time of the ranging time stamp for adjusting the safety guard time between two ONUs, e.g., the ONUs 1 and 2. The ranging time stamp 504 can also be used for automatic bandwidth adjustment.

The OLT churning control 505 (4 bytes) is used for the churning function of the PON. Churning refers to the encryption of transmission channels in the art.

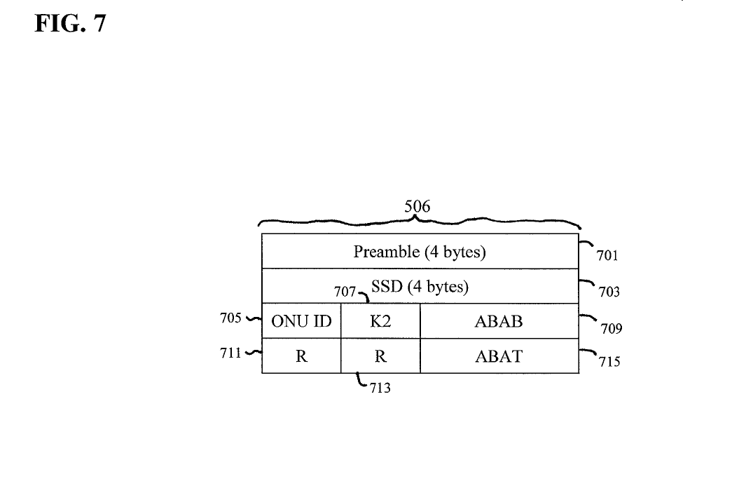

FIG. 7 is a diagram illustrating an exemplary ONU number 506 in the OLT frame 500 in the automatic ranging according to the invention. The ONU number 506, a 16-byte field, is used to instruct a particular ONU (out of the plurality of ONUs connected to the OLT 100), e.g., the ONU 1, to respond to the OLT 100 with a ranging time stamp and a churning key for the automatic ranging measurement function in the PON. The ONU number 506 contains a plurality of fields, including preamble 701, start sub-frame delimiter (SSD) 703, ONU ID 705, automatic bandwidth adjustment beginning (ABAB) 709, automatic bandwidth adjustment terminating (ABAT) 715, reserved fields K2 (707), R (711) and R (713).

The preamble 701, a 4-byte field of alternating 1s and 0s (AA, AA, AA, AA in hexadecimal), alerts the ONU (e.g., ONU 1) of the coming ONU number 506 in the OLT frame 500 and enables the synchronization of its timing. The SSD 703, a 4-byte field (6F, F6, 6F, 28 in hexadecimal) is used as a frame alignment signal to indicate the start of this subframe, namely the ONU number 506. The ONU ID 705 is used to identify a particular ONU (out of the plurality of ONUs connected to the OLT 100), e.g., the ONU 1, in the PON. The ABAB 709 and ABAT 715 are used for performing automatic bandwidth adjustment for the PON. In addition, the ABAB 709 is used for the automatic bandwidth adjustment beginning (ABAB) function in the PON. In the present embodiment, the ABAB 709 is a 2-byte field of 00, 00 in hexadecimal. The ABAT 715 is used for the automatic bandwidth adjustment terminating (ABAT) function in the PON.

Referring again to FIG. 5, the OLT EFD 507, a 4-byte field (9E, 9E, 9E, 9E in hexadecimal), is used as a frame termination signal to indicate the end of the OLT frame 500, and can also be used for the automatic ranging measurement (ARM) function in the PON.

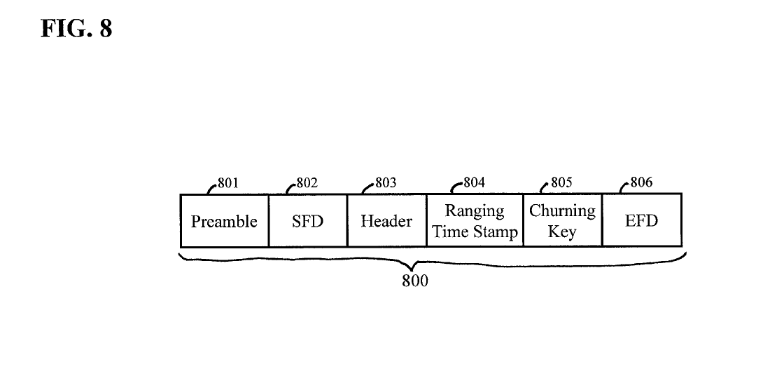

FIG. 8 is a diagram illustrating an exemplary ONU frame 800 in the automatic ranging according to the invention. According to the automatic ranging in the invention, as the OLT 100 sends the OLT frame 500 to a particular ONU (out of the plurality of ONUs connected to the OLT 100), e.g., the ONU 1, upon receipt of the OLT frame 500 the ONU (namely ONU 1) responds by sending an ONU frame 800 back to the OLT 100.

The ONU frame 800 comprises a plurality of fields, including an ONU preamble 801, an ONU start frame delimiter (SFD) 802, an ONU header 803, an ONU ranging time stamp 804, an ONU churning key 805, and an ONU end frame delimiter (EFD) 806.

The ONU preamble 801, an 8-byte (64-bit) field of alternating 1s and 0s (AA, AA, AA, AA, AA, AA, AA, AA in hexadecimal), alerts the OLT 100 to the coming ONU frame 800 and enables the synchronization of its timing. The ONU SFD 802, a 4-byte field (F6, F6, 28, 28 in hexadecimal), is used as a frame alignment signal to indicate the start of the ONU frame 800.

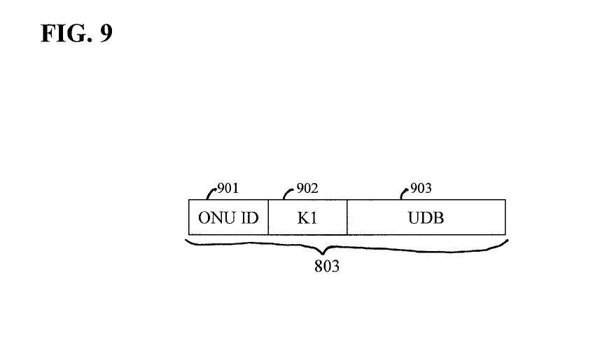

FIG. 9 is a diagram illustrating an exemplary ONU header 803 in the ONU frame 800 in the automatic ranging according to the invention. The ONU header 803 is used for the system control of the PON that identifies the particular ONU (e.g., ONU 1) from which the data are being transmitted and specifies the undelivered data block in that ONU (namely ONU 1). The ONU header 803 comprises a plurality of fields, including the ONU ID 901 (1 byte) that indicates the ONU number of the particular ONU (e.g., ONU 1) from which the data are being transmitted, another byte K1 (902) used for the protection switch function for the PON, and an undelivered data block (UDB) 903 of 2 bytes with automatic bandwidth adjustment.

Referring again to FIG. 8, the ONU ranging time stamp 804 in the ONU frame 800, a 4-byte field, is used to return the ranging time clock sent from the OLT 100. The ONU 1 copies the ranging time clock received from the OLT 100 (e.g., the OLT ranging time stamp 504) and stores it into the ONU ranging time stamp 804 for the ONU 1. The OLT 100 calculates the timing difference (i.e., the round trip time) between the receiving time, the ONU ranging time stamp 804 received from the ONU 1, and the time of the ranging time stamp for adjusting the safety guard time between two ONUs, e.g., the ONUs 1 and 2. The ONU ranging time stamp 804 can also be used for automatic bandwidth adjustment in the PON.

The ONU churning key 805, a 4-byte (32-bit) field, is used for performing the churning function of the PON. Churning refers to the encryption of transmission channels in the art.

The ONU EFD 806, a 4-byte field (9E, 9E, 9E, 9E in hexadecimal), is used as a frame termination signal to indicate the end of the ONU frame 800. The ONU EFD 806 can also be used for performing the automatic ranging measurement (ARM) function of the PON.

The automatic ranging according to the invention utilizes the OLT frame 500 sent by the OLT 100 and the ONU frame 800 returned by a particular ONU in the PON to calculate the safety guard time between two consecutive data frames in transmission. The automatic ranging according to the invention is advantageously used in a PON while one or more ONUs are added to or removed from the PON. The automatic ranging can be used in various operational scenarios, e.g., in a PON with a cold OLT, or in a warm PON with a cold ONU. A PON with a cold OLT means that the OLT has just been powered on in the PON as the automatic ranging is performed. A warm PON with a cold ONU means that the PON is already in operation while a new ONU is being added to or inserted into the PON.

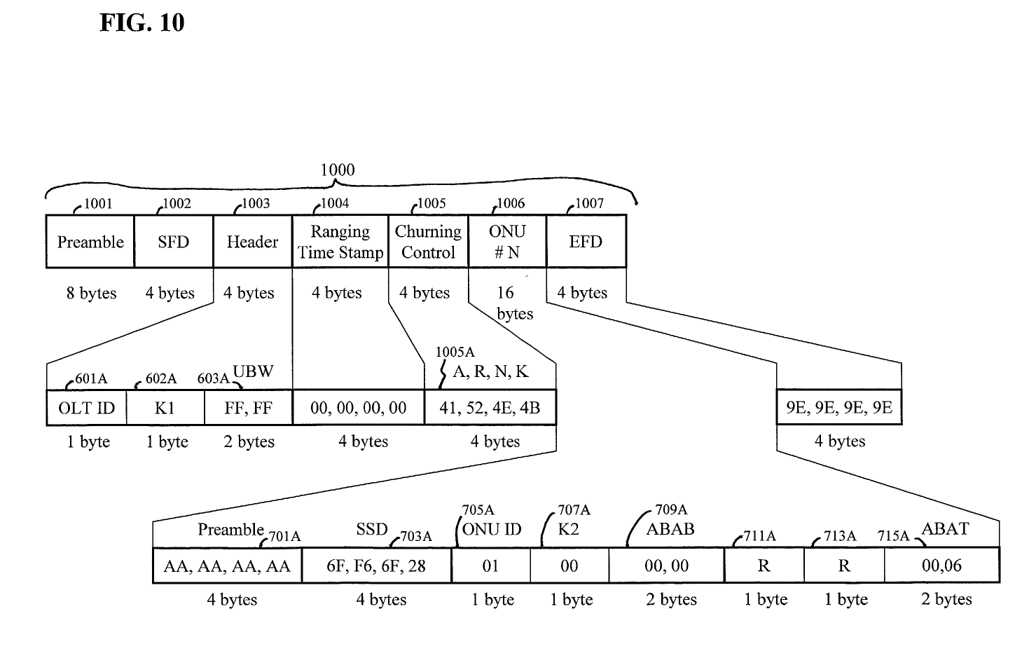

FIG. 10 is a diagram illustrating an exemplary operation of an OLT frame 1000 in the automatic ranging according to the invention in a PON with a cold OLT. The OLT frame 1000 is similar to the OLT frame 500 of FIG. 5 in general. As the OLT 100 has just been powered on, the OLT 100 sends the OLT frame 1000 to a particular ONU in the PON (e.g., ONU 1), requesting the ranging time stamp and the churning key therefrom.

Similar to the OLT frame 500 of FIG. 5, the OLT frame 1000 comprises a plurality of fields, including an OLT preamble 1001, an OLT start frame delimiter (SFD) 1002, an OLT header 1003, an OLT ranging time stamp 1004, an OLT churning control 1005, an ONU number 1006 and an OLT end frame delimiter (EFD) 1007.

The OLT preamble 1001 contains 8 bytes (64 bits) of alternating 1s and 0s (AA, AA, AA, AA, AA, AA, AA, AA in hexadecimal) that alert the ONU (e.g., ONU 1) to the coming OLT frame 1000 and enables the synchronization of its timing. The OLT SFD 1002, at 4 bytes, is used as a frame alignment signal to indicate the start of the OLT frame 1000.

The OLT header 1003 is used for the system control of the PON that identifies the OLT from which the data are being transmitted and specifies the unused bandwidth available for the PON. Similar to the OLT header 503 shown in FIG. 6, the OLT header 1003 contains three fields, including an OLT identifier 601A, at 1 byte, that indicates the OLT number on the PON (i.e., OLT 100), another byte K1 (602A) used for the protection switch function for the PON, and an unused bandwidth UBW 603A, at 2 bytes (FF, FF in hexadecimal), for the automatic bandwidth adjustment function in the PON.

The OLT ranging time stamp 1004, at 4 bytes (00, 00, 00, 00 in hexadecimal), is used to send the ranging time clock to the ONUs (e.g., ONU 1). The ONU 1, for example, copies the ranging time clock received from the OLT 100 and stores it into the OLT ranging time stamp 504 for the ONU 1. In accordance with the invention, the OLT 100 calculates the timing difference (i.e., the round trip time) between the receiving time, the ranging time stamp received from the ONU 1, and the time of the ranging time stamp for adjusting the safety guard time between two ONUs, e.g., the ONUs 1 and 2. The ranging time stamp 1004 can also be used for automatic bandwidth adjustment.

The OLT churning control 1005 (4 bytes) is used for the churning function of the PON. Churning refers to the encryption of transmission channels in the art. The OLT churning control 1005 includes an automatic ranging calculation new key request (A, R, N, K 1005A) which is 41, 52, 4E, 4B in American Standard Code for Information Interchange or ASCII, a standard coding scheme known in the art.

The ONU number 1006, a 16-byte field, is used to instruct a particular ONU (out of the plurality of ONUs connected to the OLT 100), e.g., the ONU 1, to respond to the OLT 100 with a ranging time stamp and a churning key for the automatic ranging measurement function in the PON. Similar to the ONU number 506 shown in FIG. 7, the ONU number 1006 contains a plurality of fields, including preamble 701A, start sub-frame delimiter (SSD) 703A, ONU ID 705A, automatic bandwidth adjustment beginning (ABAB) 709A, automatic bandwidth adjustment terminating (ABAT) 715A, reserved fields K2 (707A), R (711 A) and R (713A).

The preamble 701A, a 4-byte field of alternating 1s and 0s (AA, AA, AA, AA in hexadecimal), alerts the ONU (e.g., ONU 1) of the coming ONU number 1006 in the OLT frame 1000 and enables the synchronization of its timing. The SSD 703A, a 4 byte field (6F, F6, 6F, 28 in hexadecimal) is used as a frame alignment signal to indicate the start of this subframe, namely the ONU number 1006. The ONU ID 705A is used to identify a particular ONU (out of the plurality of ONUs connected to the OLT 100), e.g., the ONU 1, in the PON. The ABAB 709A and ABAT 715A are used for performing automatic bandwidth adjustment for the PON. In addition, the ABAB 709A is used for the automatic bandwidth adjustment beginning (ABAB) function in the PON. In the present embodiment, the ABAB 709A is a 2-byte field of 00, 00 in hexadecimal. The ABAT 715A, a 2-byte field of 00, 06 in hexadecimal, is used for the automatic bandwidth adjustment terminating (ABAT) function in the PON.

The OLT EFD 1007, a 4-byte field (9E, 9E, 9E, 9E in hexadecimal), is used as a frame termination signal to indicate the end of the OLT frame 1000, and can also be used for the automatic ranging measurement (ARM) function in the PON.

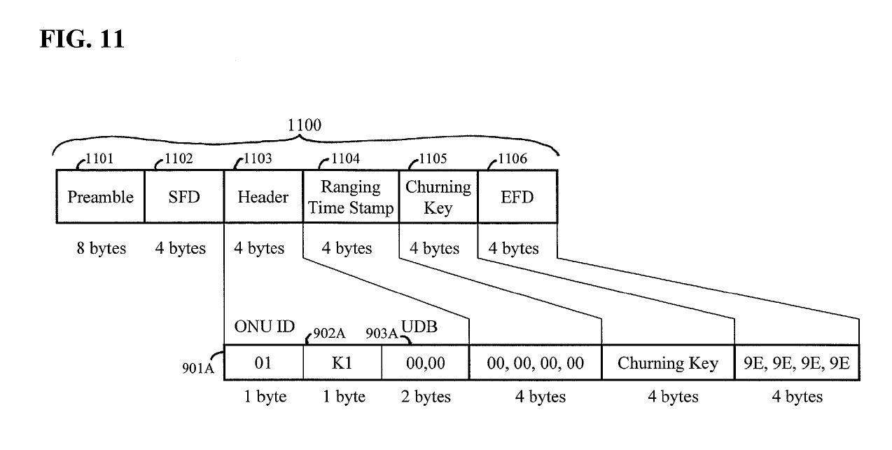

FIG. 11 is a diagram illustrating an exemplary operation of an ONU frame 1100 in the automatic ranging according to the invention in a PON with a cold OLT. The ONU frame 1100 is similar to the ONU frame 800 of FIG. 5 in general. After a particular ONU, e.g., ONU 1, receives the OLT frame 1000 sent from the OLT 100, that ONU (namely ONU 1) returns the ONU frame 1100 to the OLT 100. ONU 1 returns the ONU frame 1100 to the OLT 100 after it recognizes the value of ABAB at 00, 00 in hexadecimal. The packet length for the ONU frame 1100 is 28 bytes (as ABAT equals 0006 DW), which means that the ONU frame 1100 will terminate when the DW counter reaches 0006. In addition, the bandwidth of ONU 1 therefore is 7 DW, which is the difference between 0000 and 0006 DW.

Similar to the ONU frame 800 shown in FIG. 8, the ONU frame 1100 comprises a plurality of fields, including an ONU preamble 1101, an ONU start frame delimiter (SFD) 1102, an ONU header 1103, an ONU ranging time stamp 1104, an ONU churning key 1105, and an ONU end frame delimiter (EFD) 1106.

The ONU preamble 1101, an 8-byte (64-bit) field of alternating 1s and 0s (AA, AA, AA, AA, AA, AA, AA, AA in hexadecimal), alerts the ONU (e.g., ONU 1) to the coming ONU frame 1100 and enables the synchronization of its timing. The ONU SFD 1102, a 4-byte field (F6, F6, 28, 28 in hexadecimal), is used as a frame alignment signal to indicate the start of the ONU frame 800.

The ONU header 1103 is used for the system control of the PON that identifies the particular ONU (e.g., ONU 1) from which the data are being transmitted and specifies the undelivered data block in that ONU (namely ONU 1). Similar to the ONU header 803 in the ONU frame 800 shown in FIG. 9, the ONU header 1103 comprises a plurality of fields, including the ONU ID 901A (1 byte) that indicates the ONU number of the particular ONU (e.g., ONU 1) from which the data are being transmitted, another byte K1 (902A) used for the protection switch function for the PON, and an undelivered data block (UDB 903A) of 2 bytes (00, 00 in hexadecimal) with automatic bandwidth adjustment.

The ONU ranging time stamp 1104 in the ONU frame 1100, a 4-byte field (00, 00, 00, 00 in hexadecimal), is used to return the ranging time clock sent from the OLT 100. The ONU 1 copies the ranging time clock received from the OLT 100 (e.g., the OLT ranging time stamp 1004) and stores it into the ONU ranging time stamp 1104 for the ONU 1. The OLT 100 calculates the timing difference (i.e., the round trip time) between the receiving time, the ONU ranging time stamp 1104 received from the ONU 1, and the time of the ranging time stamp for adjusting the safety guard time between two ONUs, e.g., the ONUs 1 and 2. The ONU ranging time stamp 1104 can also be used for automatic bandwidth adjustment in the PON.

The ONU churning key 1105, a 4-byte (32-bit) field, is used for performing the churning function of the PON. Churning refers to the encryption of transmission channels in the art.

The ONU EFD 1106, a 4-byte field (9E, 9E, 9E, 9E in hexadecimal), is used as a frame termination signal to indicate the end of the ONU frame 1100. The ONU EFD 1106 can also be used for performing the automatic ranging measurement (ARM) function of the PON.

If the OLT 100 receives the ONU frame 1100 as its DW counter reaches 0000012D and ends at 00000133 (in hexadecimal), then the round-trip time between the OLT 100 and the ONU 1 is 012D DW which is the difference between 00000000 and 0000012D DW. The one-way trip time from the ONU 1 to the OLT 100 is thus 00000096 DW in hexadecimal.

The round-trip time from the OLT to each of the ONUs (e.g., ONU 2, ONU 3 and ONU 4) is accordingly calculated, similar to the exemplary operations of automatic ranging shown in FIGS. 5-11.

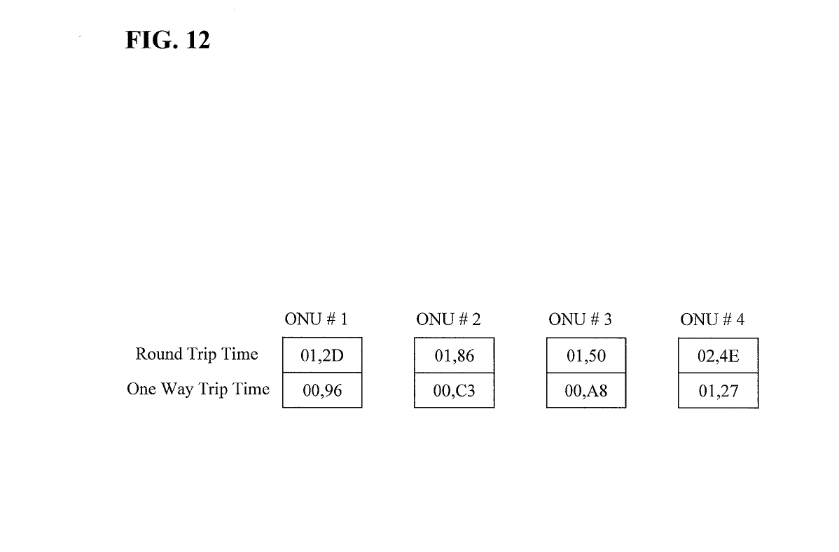

FIG. 12 is an exemplary tabulation of the round-trip time and the one-way trip time calculated for each ONU (e.g., ONU 1, ONU 2, ONU 3 and ONU 4) with respect to the OLT 100 in a PON. According to the exemplary tabulation which is a result of the calculations in an empirical embodiment for the automatic ranging in accordance with the invention, the round-trip time and the one-way trip time for ONU 1 are 01, 2D and 00, 96 in hexadecimal, respectively. The round-trip time and the one-way trip time for ONU 2 are 01, 86 and 00, C3 in hexadecimal, respectively. The round-trip time and the one-way trip time for ONU 3 are 01, 50 and 00, A8 in hexadecimal, respectively. The round-trip time and the one-way trip time for ONU 4 are 02, 4E and 01, 27 in hexadecimal, respectively.

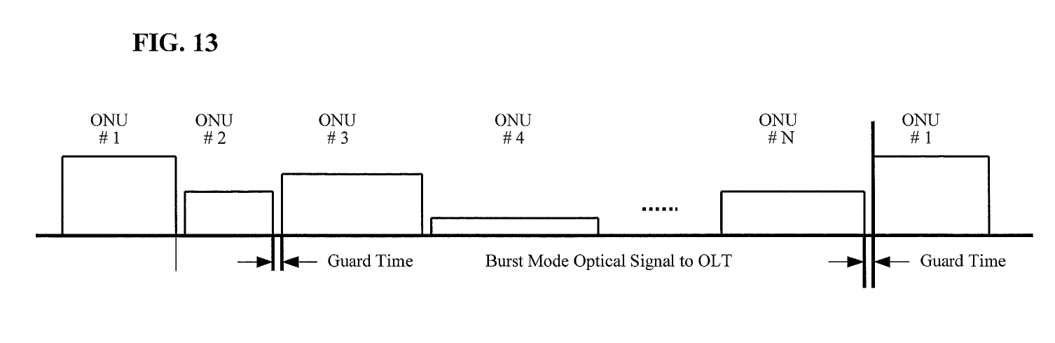

FIG. 13 is a diagram that illustrates data frames in transmission from the ONUs (ONU 1, ONU 2, ONU 3, ONU 4, . . . and ONU N) to the OLT 100. The data frames, each carrying data for each of the ONUs in the PON, travel in succession and are separated by a safety guard time between two consecutive frames. In the present embodiment, the data frames travel from the ONUs to the OLT 100 in a burst mode, which is a data transmission mode where the data are sent faster than normal.

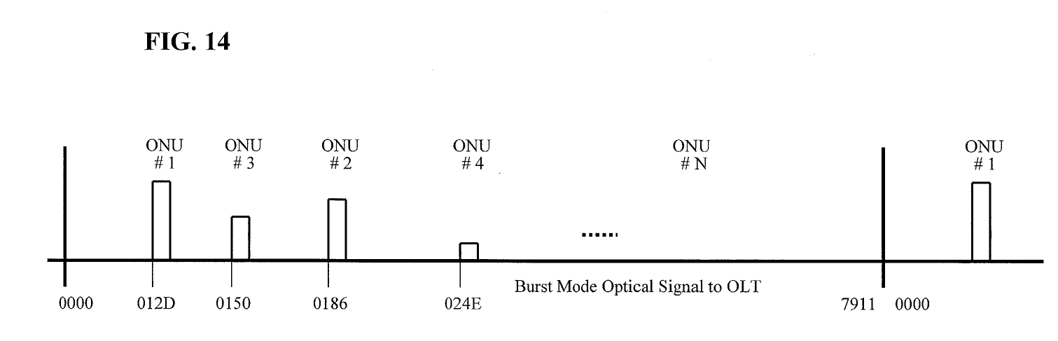

FIG. 14 is a diagram illustrating the data frames in transmission from the ONUs to the OLT 100 in the automatic ranging according to the invention. FIG. 14 assumes a bandwidth of 31,250 DW, or 7911 in hexadecimal (as marked in FIG. 14), per mini-second for a PON with a 1 gigabyte per second (Gb/s) transmission rate.

The round-trip time from the OLT to each of the ONUs (e.g., ONU 1, ONU 2, ONU 3 and ONU 4 and up to ONU N) is accordingly calculated, similar to the exemplary operations of automatic ranging shown in FIGS. 5-11. The data frames in transmission from the ONUs to the OLT 100 are accordingly rearranged (with respect to the sequence of transmission) in an optimal fashion based on the round-trip time calculations. Using the exemplary tabulation of calculations for the ONUs in FIG. 12, the data frames in transmission from the ONUs to the OLT 100 are accordingly rearranged, as shown in FIG. 14. As a result, the sequence of transmission of the data frames have been rearranged to ONU 1, ONU 3, ONU 2, ONU 4 . . . and ONU N, in accordance with their respective round-trip calculations. Using the exemplary tabulation of round-trip calculations of FIG. 12, for example, the data frame from ONU 1 to the OLT 100 is rearranged to be located at 012D corresponding to its round-trip calculation of 01, 2D in hexadecimal. The data frame from ONU 3 to the OLT 100 is rearranged to be located, behind that of the ONU 1, at 0150 corresponding to its round-trip calculation of 01, 50 in hexadecimal. The data frame from ONU 2 to the OLT 100 is rearranged to be located, behind that of the ONU 3, at 0186 corresponding to its round-trip calculation of 01, 86 in hexadecimal. The data frame from ONU 4 to the OLT 100 is rearranged to be located, behind that of the ONU 2, at 024E corresponding to its round-trip calculation of 02, 4E in hexadecimal.

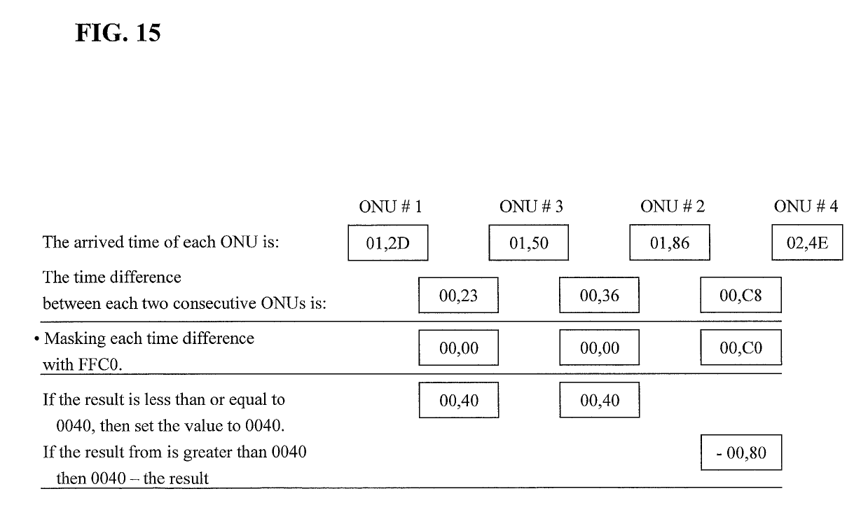

FIG. 15 is an exemplary tabulation illustrating the operation of automatic ranging according to the invention with respect to the safety guard time between two consecutive data frames in transmission from the ONUs to the OLT 100 in the PON. The arrived time of the data frames from the ONUs to the OLT 100, as shown in FIG. 14, is used to calculate the time difference between each grouping of two consecutive data frames in transmission. The time difference for each group of two consecutive data frames is shown in the exemplary tabulation of FIG. 15. The time difference between the two consecutive data frames for ONU 1 and ONU 3 (i.e., the ONU 1−ONU 3 time difference) is the difference of 01, 2D and 01, 50 which is 00, 23 in hexadecimal. The time difference between the two consecutive data frames for ONU 3 and ONU 2 (i.e., the ONU 3−ONU 2 time difference) is the difference of 01, 50 and 01, 86 which is 00, 36 in hexadecimal. The time difference between the two consecutive data frames for ONU 2 and ONU 4 (i.e., the ONU 2−ONU 4 time difference) is the difference of 01, 86 and 02, 4E which is 00, C8 in hexadecimal.

Each of the calculated time difference is then masked with FFC0. That is, the ONU 1−ONU 3 time difference is masked with FFC0 which becomes 00, 00, i.e., the ONU 1−ONU 3 masking result. The ONU 3−ONU 2 time difference is masked with FFC0 which becomes 00, 00, i.e., the ONU 3−ONU 2 masking result. The ONU 2−ONU 4 time difference is masked with FFC0 which becomes 00, C0, i.e., the ONU 2−ONU 4 masking result.

If the masking result is less than or equal to 0040, then a time difference value is set to 0040. If the masking result is greater than 0040, then the time difference value is set to the difference of 0040 and the masking result. That is, the ONU 1−ONU 3 time difference value is set to 00, 40 since the ONU 1−ONU 3 masking result is less than or equal to 0040. The ONU 3−ONU 2 time difference value is set to 00, 40 since the ONU 3−ONU 2 masking result is less than or equal to 0040. The ONU 2−ONU 4 time difference value is set to the difference of 0040 and the ONU 2−ONU 4 masking result which is −00, 80, since the ONU 2−ONU 4 masking result is greater than 0040.

The ABAB and ABAT for each of the ONUs are calculated according to the time difference values calculated for each grouping of two consecutive data frames in transmission from the ONUs to the OLT 100 in the PON. In accordance with the exemplary tabulations shown in FIGS. 12 and 15, for ONU 1 the ABAB is set to 0000 and the ABAT is accordingly 0006. Succeeding data frames are separated by the respectively calculated time difference values. For ONU 3, the ABAB is set to the sum of 0000 and 0040 which is 0040. The ABAT for ONU 3 is accordingly 0046. For ONU 2, the ABAB is set to the sum of 0040 and 0040 which is 0080. The ABAT for ONU 2 is accordingly 0086. For ONU 4, the ABAB is set to the sum of 0080 and (−0080) which is 0000. The ABAT for ONU 4 is accordingly 0006.

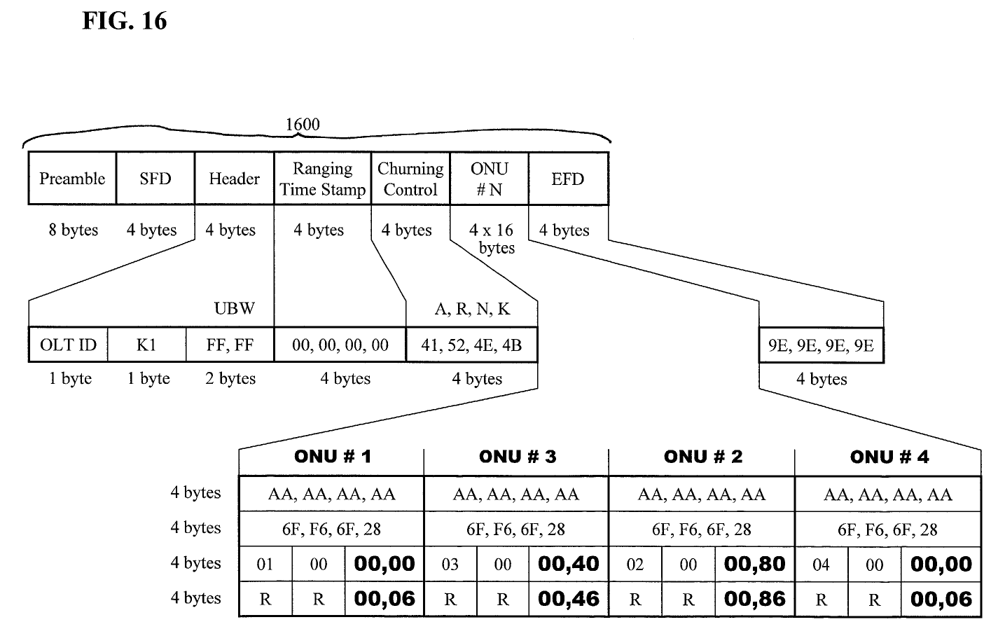

FIG. 16 is a diagram illustrating an exemplary operation of an OLT frame 1600 in the automatic ranging according to the invention taking into account the calculated time difference values for each grouping of two consecutive data frames in transmission from the ONUs to the OLT 100 in the PON. The OLT frame 1600 is similar to the OLT frame 1000 of FIG. 10 in general. Once the ABAB and ABAT for the data frames of the ONUs are calculated, they are input into the OLT frame 1000 which becomes the OLT frame 1600 shown in FIG. 16. All remain generally the same for the OLT frame 1000 and the OLT frame 1600, except the ABAB and ABAT for the ONUs, (e.g., ONU 1, ONU 2, ONU 3 and ONU 4 as particularly shown in FIG. 16). In the OLT frame 1600, for ONU 1 the ABAB is 0000 and the ABAT is 0006. For ONU 2, the ABAB is 0080 and the ABAT is 0086. For ONU 3, the ABAB is 0040 and the ABAT is 0046. For ONU 4, the ABAB is 0000 and the ABAT is 0006. For each of the ONUs, the ABAB instructs the corresponding ONU to start transmission when its DW counter counts to or reaches the same value as the ABAB, and the ABAT instructs the corresponding ONU to stop transmission when its DW counter counts to or reaches the same value as the ABAT. Accordingly, the receiving time at the OLT 100 for each of the data frames of the ONUs can be anticipated. Corresponding to the DW counter and the ABAB and ABAT for each of the ONUs, the data frame for ONU 1 will arrive at the OLT 100 when the DW count reaches 012D. Similarly, the data frame for ONU 3 will arrive at the OLT 100 when the DW count reaches the sum of 00A8 and 0040 and 00A8 which is 0190 (00A8+0040+00A8=0190). Likewise, the data frame for ONU 2 will arrive at the OLT 100 when the DW count reaches the sum of 00C3 and 0080 and 00C3 which is 0206 (00C3+0080+00C3=0206). In addition, the data frame for ONU 4 will arrive at the OLT 100 when the DW count reaches the sum of 0127 and 0000 and 0127 which is 024E (0127+0000+0127=024E).

The OLT 100 then records the DW count for each of the ONUs. For each ONU, the DW count is recorded with their respective begin time and end time for the arrival of the corresponding data frame. The recording of the DW count for each ONU ensures the data frames for the ONUs arrive at the OLT 100 in sequence properly, e.g., the arrival sequence of ONU 1, ONU 3, ONU 2 and ONU 4 in the present embodiment.

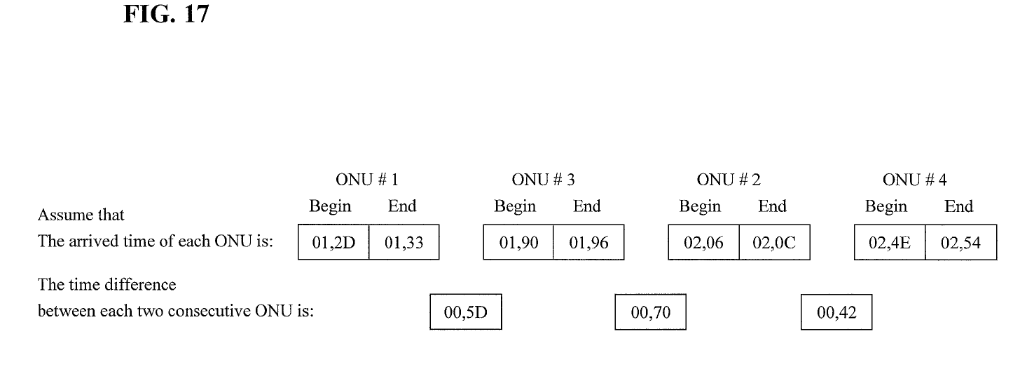

FIG. 17 is an exemplary tabulation of the begin time and end time for each of the ONUs with respect to their arrival time at the OLT 100 in the automatic ranging according to the invention. Corresponding to the DW counter and the ABAB and ABAT for each of the ONUs (as described herein above), the data frame for ONU 1 will arrive at the OLT 100 when the DW count reaches 012D which is the begin time therefor. The corresponding end time for ONU 1 is 0133. Similarly, the data frame for ONU 3 will arrive at the OLT 100 when the DW count reaches 0190 (00A8+0040+00A8=0190) which is the begin time therefor. The corresponding end time for ONU 3 is 0196. The data frame for ONU 2 will arrive at the OLT 100 when the DW count reaches 0206 (00C3+0080+00C3=0206) which is the begin time therefor. The corresponding end time for ONU 2 is 020C. Moreover, the data frame for ONU 4 will arrive at the OLT 100 when the DW count reaches 024E (0127+0000+0127=024E) which is the begin time therefor. The corresponding end time for ONU 4 is 0254.

The time difference for each grouping of two consecutive data frames in transmission between the ONUs and the OLT 100 is accordingly shown in the exemplary tabulation of FIG. 17. That is, the time difference between the two consecutive data frames for ONU 1 and ONU 3 (i.e., the ONU 1−ONU 3 time difference) is the difference of 01, 33 and 01, 90 which is 00, 5D in hexadecimal. Likewise, the time difference between the two consecutive data frames for ONU 3 and ONU 2 (i.e., the ONU 3−ONU 2 time difference) is the difference of 01, 96 and 02, 06 which is 00, 70 in hexadecimal. The time difference between the two consecutive data frames for ONU 2 and ONU 4 (i.e., the ONU 2−ONU 4 time difference) is the difference of 02, 0C and 02, 4E which is 00, 42 in hexadecimal. The time difference between each grouping of two consecutive data frames in transmission should be greater than or equal to 0030 to properly serve as a safety guard time therefor.

The automatic ranging according to the invention is advantageously used in a PON while one or more ONUs are added to or removed from the PON. The automatic ranging can be used in various operational scenarios, e.g., in a PON with a cold OLT, or in a warm PON with a cold ONU. A PON with a cold OLT means that the OLT has just been powered on in the PON as the automatic ranging is performed. A warm PON with a cold ONU means that the PON is already in operation while a new ONU is being added to or inserted into the PON.

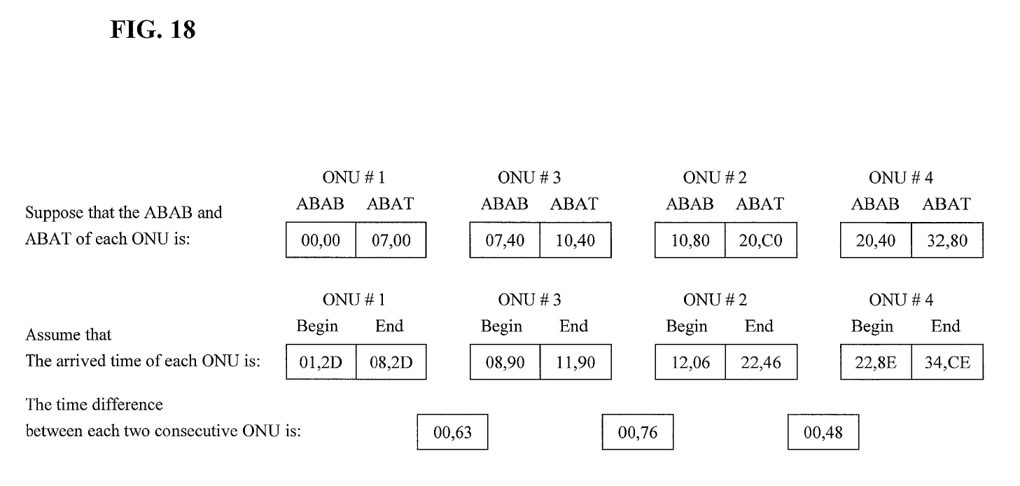

FIG. 18 is another exemplary tabulation illustrating the operation of automatic ranging according to the invention with respect to the ABAB, ABAT and the time difference between two consecutive data frames in transmission from the ONUs to the OLT 100 in the PON. FIG. 18 describes the automatic ranging according to the invention in conjunction with the PON of FIG. 4 wherein the warm PON with ONU 1, ONU 2, ONU 3 and ONU 4 are already in service and a cold ONU E is to be added to or inserted into the PON. For the automatic ranging according to the invention, the OLT 100 instructs the ONUs to temporarily stop the transmission of lower priority data frames for several mini-seconds, thereby allowing the insertion of the cold ONU E into the PON.

The data frames corresponding to the ONUs and travel in succession, i.e., traveling in the order of ONU 1, ONU 3, ONU 2 and ONU 4 as shown in FIG. 14. In accordance with the exemplary tabulation shown in FIG. 18, for ONU 1 the ABAB is 00, 00 and the ABAT is 07, 00. Moreover, for ONU 3 the ABAB is 07, 40 and the ABAT is 10, 40. For ONU 2, the ABAB is 10, 80 and the ABAT is 20, C0. For ONU 4, the ABAB is 20, 40 and the ABAT is 32, 80.

The arrived time of the data frames from the ONUs to the OLT 100, as shown in the exemplary tabulation in FIG. 18, is used to calculate the time difference between each grouping of two consecutive data frames in transmission. The data frame for ONU 1 will arrive at the OLT 100 at 01, 2D (in hexadecimal) which is the begin time therefor. The corresponding end time for ONU 1 is 08, 2D (in hexadecimal). Similarly, the data frame for ONU 3 will arrive at the OLT 100 at 08, 90 (in hexadecimal) which is the begin time therefor. The corresponding end time for ONU 3 is 11, 90 (in hexadecimal). The data frame for ONU 2 will arrive at the OLT 100 at 12, 06 (in hexadecimal) which is the begin time therefor. The corresponding end time for ONU 2 is 22, 46 (in hexadecimal). Moreover, the data frame for ONU 4 will arrive at the OLT 100 at 22, 8E (in hexadecimal) which is the begin time therefor. The corresponding end time for ONU 4 is 34, CE (in hexadecimal). The OLT 100 records 34, CE which is when the last data frame has arrived (e.g., in DW count).

The time difference for each group of two consecutive data frames is shown in the exemplary tabulation of FIG. 18, similar to the exemplary calculations of the time difference shown in FIG. 17. The time difference between the two consecutive data frames for ONU 1 and ONU 3 (i.e., the ONU 1−ONU 3 time difference) is the difference of 01, 2D and 08, 2D which is 00, 63 in hexadecimal. The time difference between the two consecutive data frames for ONU 3 and ONU 2 (i.e., the ONU 3−ONU 2 time difference) is the difference of 11, 90 and 12, 06 which is 00, 76 in hexadecimal. The time difference between the two consecutive data frames for ONU 2 and ONU 4 (i.e., the ONU 2−ONU 4 time difference) is the difference of 22, 46 and 22, 8E which is 00, 48 in hexadecimal.

As the arrived time for the last data frame, i.e., 34, CE, is recorded in the OLT 100, it is replaced with an offset value of 35, 00 which is set to be the new value for the ABAB of ONU 1. The OLT 100 accordingly re-arranges or resets the ABAB and ABAT for each of the ONUs and allows the insertion of the cold ONU E into the OLT frame.

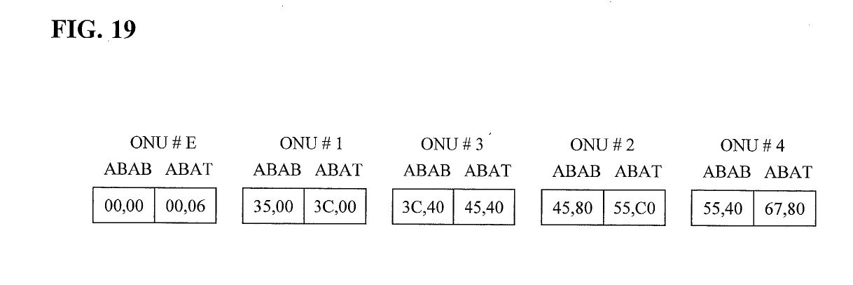

FIG. 19 is a further exemplary tabulation illustrating the operation of automatic ranging according to the invention with respect to the automatic bandwidth adjustment beginning (ABAB) and the automatic bandwidth adjustment terminating (ABAT) with respect to consecutive data frames in transmission from the ONUs (including the cold ONU E) to the OLT 100 in the PON. The calculations for the ABAB and ABAT are similar to those described in conjunction with FIGS. 17 and 18. Once the OLT 100 re-arranges or resets the ABAB and ABAT for ONU 1 with the offset value of 35, 00, ONU 3, ONU 2 and ONU 4 accordingly, the insertion of the cold ONU E into the OLT frame is permitted. In accordance with the exemplary tabulation shown in FIG. 19, for ONU E the ABAB is 00, 00 and the ABAT is 00, 06. In accordance with the offset value of 35, 00, for ONU 1 the ABAB is 35, 00 and the ABAT is 3C, 00. Moreover, for ONU 3 the ABAB is 3C, 40 and the ABAT is 45, 40. For ONU 2, the ABAB is 45, 80 and the ABAT is 55, C0. For ONU 4, the ABAB is 55, 40 and the ABAT is 67, 80.

After the insertion of the cold ONU E into the PON and the respective ABAB and ABAT for each of the ONUs (including ONU E) are reset, the arrived time of the ONU E is measured and the OLT 100 accordingly instructs each ONU (including ONU E) to transmit a new sequence of data frames corresponding to the arrived time of all of the ONUs, including ONU E.

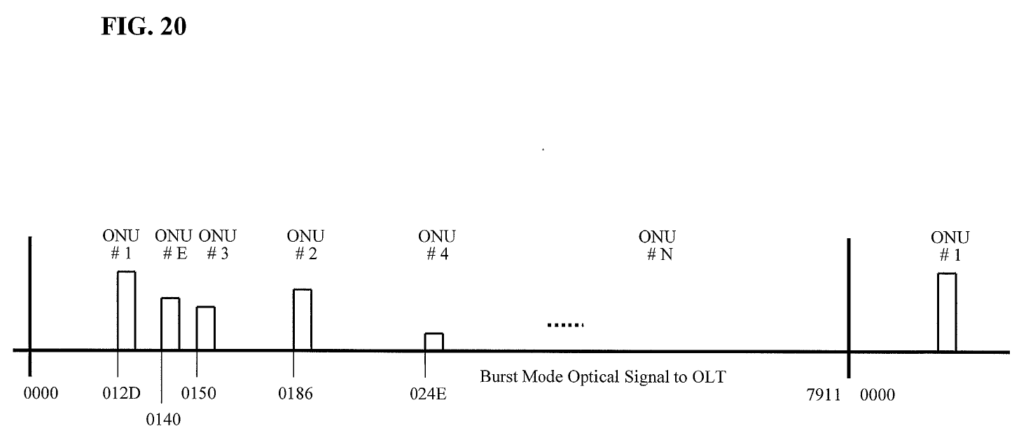

FIG. 20 is a diagram illustrating the data frames in transmission from the ONUs (including a newly inserted ONU E) to the OLT 100 of the PON in the automatic ranging according to the invention. Once the arrived time of the ONU E is measured (e.g., 01, 40), the OLT 100 waits for a time interval (e.g., several mini-seconds) and instructs each of the ONUs to transmit a new sequence of data frames corresponding to their respective arrived times, e.g., in the order of ONU 1, ONU E, ONU 3, ONU 2, ONU 4 . . . and up to ONU N, as shown in FIG. 20.

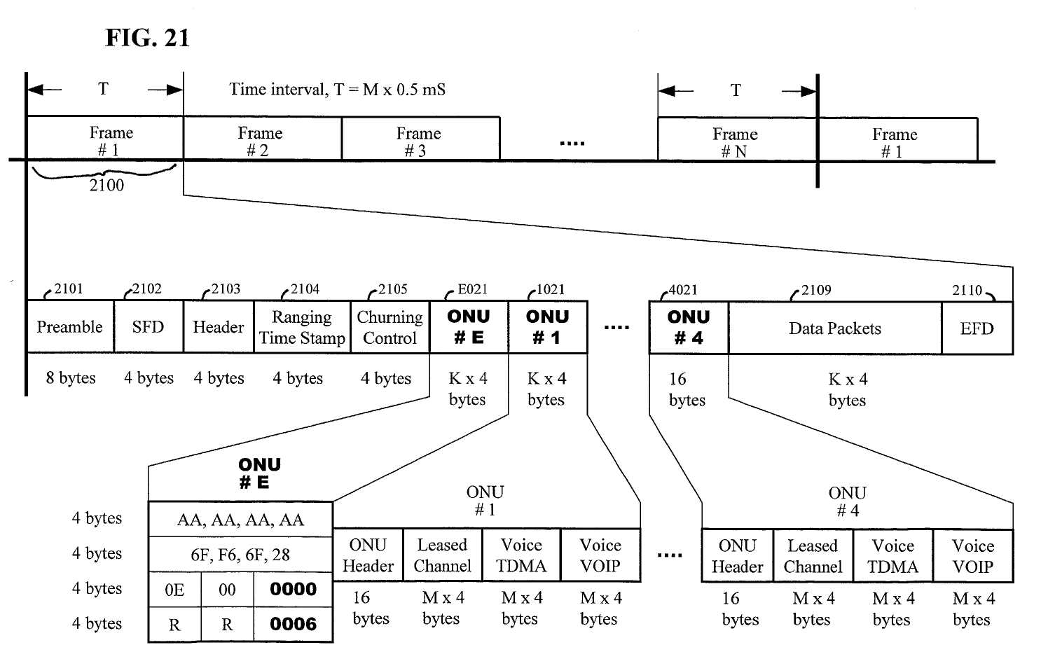

FIG. 21 is a diagram illustrating an exemplary downstream data frame 2100 as the cold ONU E is being inserted into the PON in the automatic ranging according to the invention. The downstream frame 2100 is similar to the downstream data frame described and claimed in the related U.S. patent application Ser. No. 09/792,309 filed on Feb. 23, 2001 and entitled “IP PACKETIZED FRAME FORMAT IN A PASSIVE OPTICAL NETWORK” which is incorporated herein by reference. The data being transported downstream include 1, 2, 3 and N frames, one for each of the ONU in the PON. The time interval T for each of the frames is M×0.5 milliseconds (ms). Particularly shown in FIG. 21 is the downstream data frame 2100 for carrying data or information from the OLT 100 to the ONUs (e.g., ONU E, ONU 1, ONU 2, ONU 3, ONU 4) as the cold ONU E is being inserted into the PON.

The downstream frame 2100 comprises a plurality of fields, including a downstream preamble 2101, a downstream start frame delimiter (SFD) 2102, a downstream header 2103, a downstream ranging time stamp 2104, a churning control 2105, a downstream data packet channel 2109, and a downstream end frame delimiter (EFD) 2110. In addition, the downstream frame 2100 further comprises data frames E021, 1021, . . . and 4021 for ONU E, ONU 1, . . . and ONU 4, respectively.

The preamble 2101 contains 8 bytes (64 bits) of alternating 1s and 0s that alert each of the ONUs of the coming downstream frame 2100 and enables the synchronization of its timing. The SFD 2102, at 4 bytes, is used as a frame alignment signal to indicate the start of the downstream frame 2100.

The header 2103 is used for the system control of the PON that identifies the OLT 100 from which the data are being transmitted and specifies the unused bandwidth available for the PON. The header 2103 includes an OLT identifier (1 byte) that indicates the OLT number on the PON (i.e., OLT 100), another byte K1 used for the protection switch and automatic ranging functions for the PON, and an unused bandwidth (UBW) field of 2 bytes with automatic bandwidth adjustment.

The ranging time stamp 2104 is used to send the ranging time clock to each of the ONUs. The ONU 1, for example, copies the ranging time clock received from the OLT 100 and stores it into the ranging time stamp 2104 for the ONU 1. The OLT 100 calculates the timing difference (i.e., the round trip time) between the receiving time, the ranging time stamp received from the ONU 1, and the time of the ranging time stamp for adjusting the safety guard time between two consecutive data frames. The ranging time stamp 2104 can also be used for automatic bandwidth adjustment.

The churning control 2105 (4 bytes) is used for the churning function of the PON and performing the new churning key request. Churning refers to the encryption of transmission channels in the art.

The downstream data packet channel 2109, a K×4-byte field where K is an integer, is used to transport the data packets with lower priority (such as computer data files or image pictures) to a particular ONU. The maximum payload length for each data packet in the channel 2109 is 2048 bytes. The data packet channel 2109 further comprises a plurality of fields including a data packet header (DPH), a priority (PRIO), a loopback (LPBK), a residential gateway number (RGN), a payload length, a payload, and a bit interleaved parity 32 (BIP-32). The BIP-32 is used for monitoring the bit error ratio (BER) on the transmission link for transporting the data. Parity checking is the use of parity bits to check that the data have been transmitted properly. The parity bit (e.g., BIP-32) is added to every data unit being transmitted. Each of the bits of the BIP-32 is the result of an exclusive-or (XOR) operation of all the same position bits in all the payload field prior to scrambling.

The DPH indicates the start of the data packet channel 2109. The PRIO defines the priority level of the data packets therein with respect to the data traffic flow, e.g., a value of 0 representing the lowest priority and 15 representing the highest. The LPBK defines the loopback function for the data packets in the channel 2109. The RGN identifies the residential gateway connected to a particular ONU. A gateway is a combination of hardware and software that links two different types of networks, i.e., the PON and the particular ONU at the residence or location of an end user. The payload length defines the total payload length for the data packets in the channel 2109. The payload length includes payload only, but not the bytes of the BIP-32. The payload contains the data packets of the channel 2109, with a maximum payload length of 2048 for each data packet.

The EFD 2110, a 4-byte field, is used as a frame termination signal to indicate the end of the downstream frame 2100.

In addition, the downstream frame 2100 further comprises data frames E021, 1021, . . . and 4021 for ONU E, ONU 1, . . . and ONU 4, respectively. Particularly shown in FIG. 21 are the fields E021, 1021 and 4021 for ONU E, ONU 1 and ONU 4, respectively. For example, the frame 1021 comprises an ONU header, a leased channel, a voice TDMA channel, and a voice VOIP channel. The structure of the data frames corresponding to the other ONUs (except ONU E), namely ONU 3, ONU 2 and ONU 4 (4021), is similar to that of the frame 1021 for ONU 1.

TDMA stands for time division multiple access, and VOIP stands for voice over Internet protocol. TDMA is a technology for delivering digital wireless service using time division multiplexing or TDM. TDMA works by dividing a radio frequency into time slots and allocating the slots to multiple calls (such as local calls), thereby allowing a single frequency to support multiple, generally simultaneous data channels. Note that TDM is a type of multiplexing that combines data streams by assigning each stream a different time slot in a set. TDM repeatedly transmits a fixed sequence of time slots over a single transmission channel. In addition, VOIP is a type of Internet telephony (i.e., an Internet telephony application over the Internet protocol or IP) which is a category of hardware and software that enable end users to use the Internet as the transmission medium for telephone calls.

With reference to the frame 1021 for ONU 1 in particular, the ONU header, a 16-byte field, identifies the specific ONU, i.e., ONU 1. The leased channel is M×4 byte field (M being an integer) which is used to transport data, such as TDM or IP data from the OLT 100 to another network connected therewith such as a public switched telephone network (PSTN) or an IP network. PSTN refers to the international telephone system based on copper wires carrying analog voice data. A leased channel or leased line is a generally permanent and constantly active connection between two points set up by a telecommunications carrier, e.g., a T-1, T-3, DS1, E1, DS3, or E3 channel for accessing the Internet. A T-1 channel (sometimes referred to as a DS1 channel) is a dedicated telephone connection supporting transmission data rates of generally 1.544 megabits per second (Mbps). A T-3 channel (sometimes referred to as a DS3 channel) is a dedicated telephone connection supporting data rates of generally 44.736 Mbps. Moreover, an E-1 channel is a dedicated telephone connection supporting data rates of generally 2.048 Mbps. An E-3 channel is a dedicated telephone connection supporting data rates of generally 34.368 Mbps.

The frame 1021 also includes a voice TDMA channel, an M×4 byte field where M is an integer, is used to transport local call voice data packets to the OLT 100. The voice VOIP channel, also an M×4-byte field, is used to transport long distance call data packets to the PSTN or the IP network (if any) via the OLT 100. The leased channel, voice TDMA channel and the voice VOIP channel are described in further detail in the related U.S. patent application Ser. No. 09/792,309 filed on Feb. 23, 2001 and entitled “IP PACKETIZED FRAME FORMAT IN A PASSIVE OPTICAL NETWORK.”

The structure of the frame E021, at K×4 bytes where K is an integer, is similar to the ONU number field of FIGS. 10 and 16. The frame E021 contains a plurality of fields, including a preamble, a start sub-frame delimiter (SSD), an ONU ID, an ABAB, an ABAT, reserved fields K2 (00), R and R. The preamble, a 4-byte field of alternating 1s and 0s (AA, AA, AA, AA in hexadecimal), alerts the ONU (e.g., ONU E) of the coming frame E021 in the downstream frame 2100 and enables the synchronization of its timing. The SSD, a 4-byte field (6F, F6, 6F, 28 in hexadecimal) is used as a frame alignment signal to indicate the start of this subframe, namely the frame E021. The ONU ID, at 0E, is used to identify a particular ONU (out of the plurality of ONUs connected to the OLT 100), e.g., the ONU E, in the PON. The ABAB and ABAT are used for performing automatic bandwidth adjustment for the PON. In addition, the ABAB can be used for the automatic bandwidth adjustment beginning (ABAB) function in the PON, as described herein. In the present embodiment, the ABAB is a 2-byte field of 00, 00 in hexadecimal. The ABAT 715A, a 2-byte field of 00, 06 in hexadecimal, is used for the automatic bandwidth adjustment terminating (ABAT) function in the PON, as described herein.

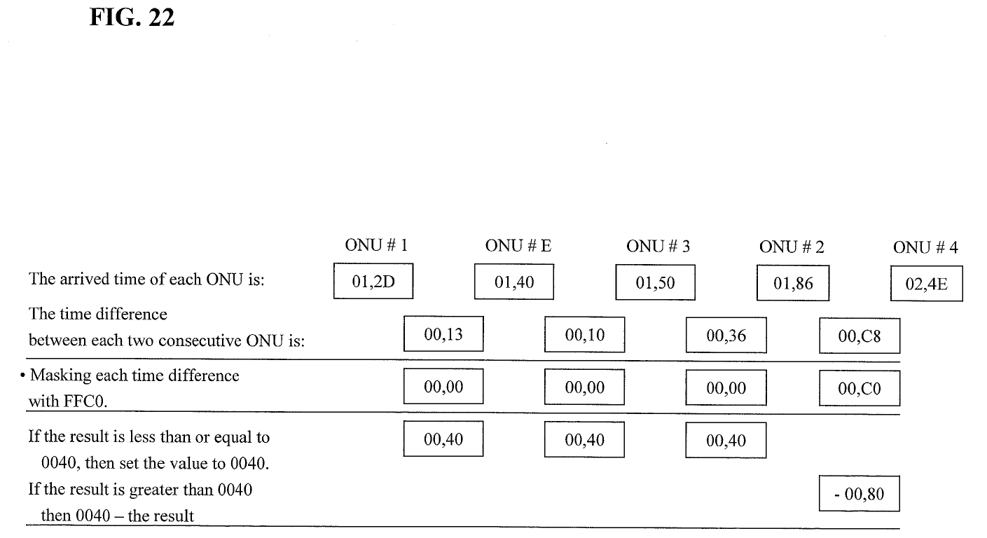

FIG. 22 is an exemplary tabulation illustrating the operation of automatic ranging according to the invention with respect to the safety guard time between two consecutive data frames in transmission from the ONUs to the OLT 1 00 as a cold ONU E is being inserted into the PON. The operation of the automatic ranging described in FIG. 22 is similar to the operation described in FIG. 15, and is described herein in conjunction with the downstream frame 2100 of FIG. 21.

The arrived time of the data frames from the ONUs to the OLT 100, as shown in FIG. 22, is used to calculate the time difference between each grouping of two consecutive data frames in transmission. In accordance with the exemplary tabulation in FIG. 22, the arrived time of the data frame for ONU 1 is 01, 2D in hexadecimal, for ONU E is 01, 40, for ONU 3 is 01, 50, for ONU 2 is 01, 86, and for ONU 4 is 02, 4E.

The time difference for each group of two consecutive data frames is shown in the exemplary tabulation of FIG. 22. The time difference between the two consecutive data frames for ONU 1 and ONU E (i.e., the ONU 1−ONU E time difference) is the difference of 01, 2D and 01, 40 which is 00, 13 in hexadecimal. The time difference between the two consecutive data frames for ONU E and ONU 3 (i.e., the ONU E−ONU 3 time difference) is the difference of 01, 40 and 01, 50 which is 00, 10 in hexadecimal. The time difference between the two consecutive data frames for ONU 3 and ONU 2 (i.e., the ONU 3−ONU 2 time difference) is the difference of 01, 50 and 01, 86 which is 00, 36 in hexadecimal. The time difference between the two consecutive data frames for ONU 2 and ONU 4 (i.e., the ONU 2−ONU 4 time difference) is the difference of 01, 86 and 02, 4E which is 00, C8 in hexadecimal.

Each of the calculated time difference is then masked with FFC0. That is, the ONU 1−ONU E time difference is masked with FFC0 which becomes 00, 00, i.e., the ONU 1−ONU E masking result. The ONU E−ONU 3 time difference is masked with FFC0 which becomes 00, 00, i.e., the ONU E−ONU 3 masking result. The ONU 3−ONU 2 time difference is masked with FFC0 which becomes 00, 00, i.e., the ONU 3−ONU 2 masking result. The ONU 2−ONU 4 time difference is masked with FFC0 which becomes 00, C0, i.e., the ONU 2−ONU 4 masking result.

If the masking result is less than or equal to 0040, then a time difference value is set to 0040. If the masking result is greater than 0040, then the time difference value is set to the difference of 0040 and the masking result. That is, the ONU 1−ONU 3 time difference value is set to 00, 40 since the ONU 1−ONU 3 masking result is less than or equal to 0040. The ONU E−ONU 3 time difference value is set to 00, 40 since the ONU E−ONU 3 masking result is less than or equal to 0040. The ONU 3−ONU 2 time difference value is set to 00, 40 since the ONU 3−ONU 2 masking result is less than or equal to 0040. The ONU 2−ONU 4 time difference value is set to the difference of 0040 and the ONU 2-ONU 4 masking result which is −00, 80, since the ONU 2−ONU 4 masking result is greater than 0040.

The ABAB and ABAT for each of the ONUs are calculated according to the time difference values calculated for each grouping of two consecutive data frames in transmission from the ONUs to the OLT 100 in the PON. In accordance with the exemplary tabulations shown in FIG. 22, for ONU 1 the ABAB is set to 0000 and the ABAT is accordingly the sum of 0000 and 0700 which is 0700 (0000+0700=0700). Succeeding data frames are separated by the respectively calculated time difference values. For ONU E, the ABAB is set to the sum of 0700 (ABAT for ONU 1) and 0040 (time difference value for ONU E) which is 0740 (0070+0040=0740). The ABAT for ONU E is accordingly the sum of 0740 (ABAB for ONU E) and 0006 which is 0746 (0740+0006=0746). For ONU 3, the ABAB is set to the sum of 0740 (ABAB for ONU E) and 0040 (time difference value for ONU 3) which is 0780 (0740+0040=0780). The ABAT for ONU 3 is accordingly the sum of 0780 (ABAB for ONU 3) and 0900 which is 1080 (0780+0090=1080). For ONU 2, the ABAB is set to the sum of 1080 (ABAT for ONU 3) and 0040 (time difference value for ONU 2) which is 10C0 (1080+0040=10C0). The ABAT for ONU 2 is accordingly the sum of 10C0 (ABAB for ONU 2) and 1040 which is 2100 (10C0+1040=2100). For ONU 4, the ABAB is set to the sum of 2100 (ABAT for ONU 2) and (−0080) (time difference value for ONU 4) which is 2080 (2100+(−0080)=2080). The ABAT for ONU 4 is accordingly the sum of 2080 (ABAB for ONU 4) and 1240 which is 32C0 (2080+1240=32C0).

As these calculations are being performed, each of the ONUs transport the data with higher priority in the data frames. After the calculations are complete, the OLT 100 instructs the ONUs to transmit the data frames in a new sequence (i.e., ONU 1, ONU E, ONU 3, ONU 2 and ONU 4) with the new values for each ABAB and ABAT. In order to maintain a proper safety guard time between two consecutive data frames in transmission, the time difference between two consecutive frames is ensured to be greater than or equal to 0030, as described herein in conjunction with FIG. 17.

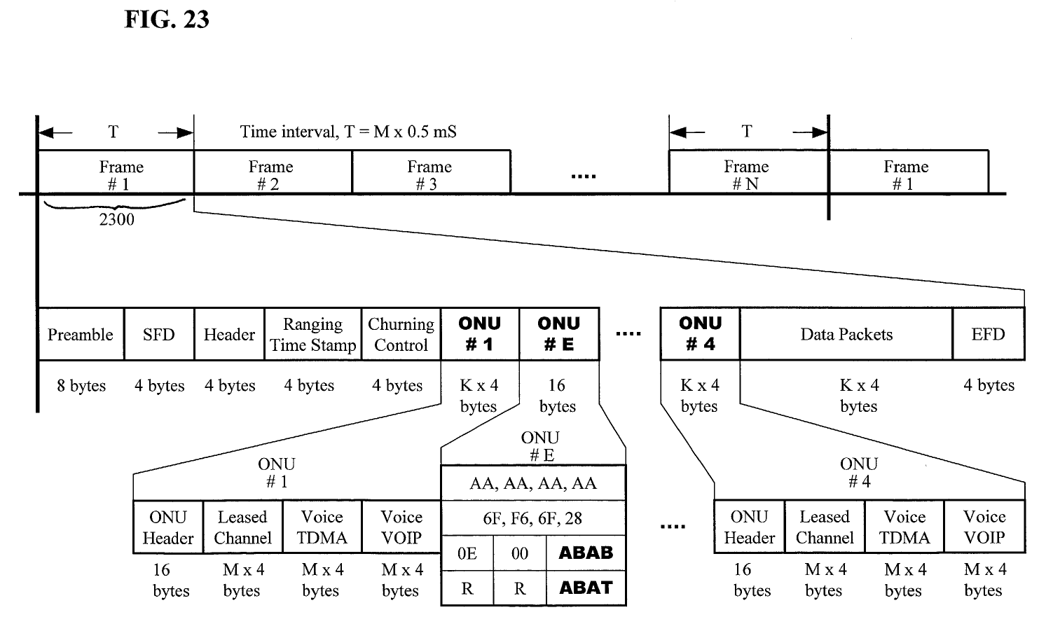

FIG. 23 is a diagram illustrating an exemplary downstream data frame 2300 after the ONU E is properly inserted into the PON in the automatic ranging according to the invention. The structure of the downstream frame 2300 is similar to the downstream data frame described and claimed in the related U.S. patent application Ser. No. 09/792,309 filed on Feb. 23, 2001 and entitled “IP PACKETIZED FRAME FORMAT IN A PASSIVE OPTICAL NETWORK.”

The new sequence of the transmission of the data frames for the ONUs (including the newly inserted ONU E) is described in FIG. 23 in conjunction with FIGS. 20 and 22, namely the transmission sequence of ONU 1, ONU E, ONU 3, ONU 2 and ONU 4. The downstream frame 2300 is generally the same as the downstream frame 2100 of FIG. 21, except that the sequence of the frames for ONU E, ONU 1, ONU 3, ONU 2 and ONU 4 in FIG. 21 has changed to a new sequence for the frames for ONU 1, ONU E, ONU 3, ONU 2 and ONU 4 in FIG. 23. In addition, FIG. 23 shows the frame for ONU E is transporting data, since it comprises an ONU header, a leased channel, a voice TDMA channel and a voice VOIP channel which is generally the same as the other frames for ONU 1, ONU 3, ONU 2 and ONU 4.

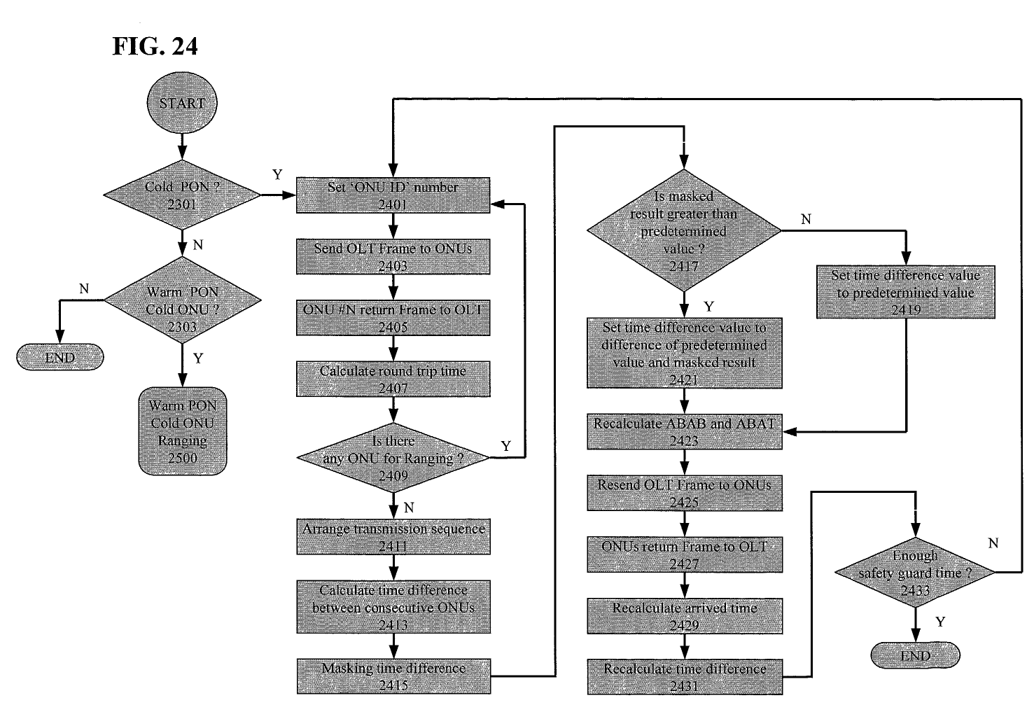

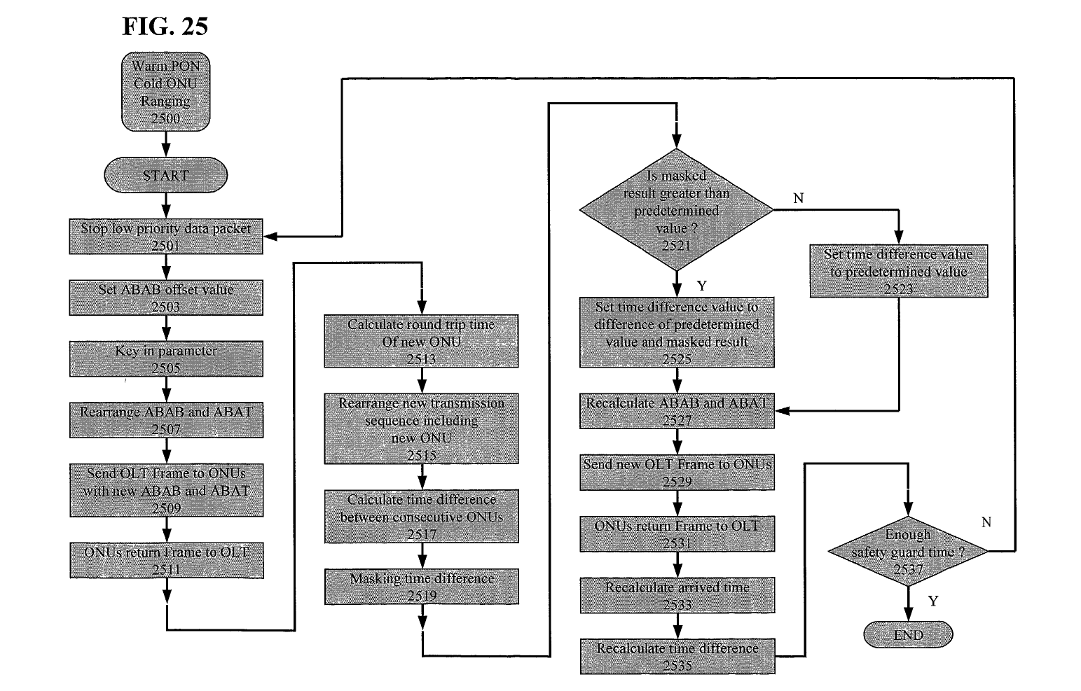

FIGS. 24 and 25 are flow diagrams illustrating a particular embodiment of the automatic ranging method in a PON according to the invention. Using the automatic ranging method according to the invention, the PON can determine the safety guard time between two consecutive ONUs and allow the insertion or removal of an ONU into or from the PON without seriously interrupting the operation thereof. The automatic ranging method in accordance with the invention is herein illustrated and described for use in a tree-type PON in the present embodiment. It is nonetheless suitable for any type of PON networking structure in the art.

As ONU E is to be inserted into the PON having a plurality of ONUs (including at least ONU 1, ONU 2, ONU 3 and ONU 4) connected to the OLT 100 (FIG. 4), it is determined in step 2301 whether the PON is a cold PON. A cold PON is one with an OLT that has just been powered on and the ONUs connected therewith are already powered. If the ONUs are powered on after the OLT, then the PON is not a cold PON, but a warm PON with cold ONUs. If it is determined in step 2301 that the PON is not a cold PON, then the control flow is directed to step 2303. If it is determined in step 2301 that the PON is a cold PON, then the control flow is directed to step 2401.

In step 2303, it is determined whether the PON is a warm PON with cold ONUs. The PON is a warm PON with cold ONUs if the PON is in service when there is one or more ONUs to be inserted into the PON. If it is determined in step 2303 that the PON is not a warm PON with cold ONUs, then the control flow is ended. If it is determined in step 2303 that the PON is a warm PON with cold ONUs, then the control flow is directed to step 2500, which is further described in FIG. 25.

In step 2401, the ONU ID 705A is input into the OLT frame 1000 (as shown herein and in conjunction with, e.g., FIG. 10). In step 2403, the OLT frame 1000 is respectively sent to the ONUs in requesting the ranging time stamp and the churning key. In step 2405, the ONUs (e.g., ONU N) respectively return the ONU frame 1100 (as shown herein and in conjunction with, e.g., FIG. 11) in response to the OLT frame 1000 from the OLT 100. An ONU returns the ONU frame 1100 in response as soon as it recognizes the value of ABAB of 00,00. The packet length for the ONU frame 1100 is 28 bytes (i.e., ABAT equals 0006 DW), which indicates packet termination therefor when the DW count reaches 0006. The bandwidth for each of the ONUs is 7 DW (0000-0006).

In step 2407, the round trip time for the OLT 100 to reach the ONUs is accordingly calculated, similar to the exemplary operations of automatic ranging shown in FIGS. 5-11. For example, as the OLT 100 receives the returning ONU frame 1100 as its DW count reaches 012D and ends at 0133, then the round trip time between the OLT 100 and the ONU (from which the ONU frame 1100 is sent, e.g., ONU 1) is 012D minus 0000 which equals 012D DW. The one-way trip time from this particular ONU (e.g., ONU 1) to the OLT 100 is thus 0096 DW.

In step 2409, it is determined whether there is a need for automatic ranging for further ONUs (i.e., whether another ONU is to be inserted or added into the PON). This determination is made since the automatic ranging according to the invention is performed for one ONU at a time for insertion into or removal from the PON. If it is determined in step 2409 that automatic ranging is needed for more ONUs, then the control flow is reverted back to step 2401. If it is determined in step 2409 that no further automatic ranging is needed for other ONUs, then the control flow is directed to step 2411.

In step 2411, the transmission sequence for the ONUs is arranged. The OLT 100 by now has calculated the round trip time of for the ONUs, e.g., 012D for ONU 1, 0186 for ONU 2, 0150 for ONU 3 and 024E for ONU 4 (as shown herein and in conjunction with, e.g., FIG. 12). The one-way trip time for each of the ONUs is accordingly calculated, e.g., 0096 for ONU 1, 00C3 for ONU 2, 00A8 for ONU 3, 0127 for ONU 4 (as shown herein and in conjunction with, e.g., FIG. 12). The OLT 100 arranges the transmission sequence for the ONUs according to the arrived time from the least to the longest (i.e., from the nearest to the farthest), which is exemplarily illustrated in FIG. 14).

In step 2413, the time difference between consecutive ONUs in the transmission sequence is calculated (as shown herein and in conjunction with, e.g., FIG. 15). In step 2415, the time difference between consecutive ONUs is masked and yields a corresponding masking result (as shown herein and in conjunction with, e.g., FIG. 15). In step 2417, it is determined whether the masking result is greater than a predetermined value. If it is determined in step 2417 that the masking result is greater than the predetermined value, then the control flow is directed to step 2421. If it is determined in step 2417 that the masking result is not greater than the predetermined value, then the control flow is directed to step 2419.

In step 2419, a time difference value is set to the predetermined value (as shown herein and in conjunction with, e.g., FIG. 15) and the control flow is directed to step 2423. In step 2421, the time difference value is set to the difference of the predetermined value and the masking result (as shown herein and in conjunction with, e.g., FIG. 15). In step 2423, the ABAB and ABAT are accordingly recalculated (illustrated in conjunction with FIGS. 15 and 16). In step 2425, the recalculations in step 2423 are input into the OLT frame which is then resent to the ONUs (frame 1600 of FIG. 16). As the OLT frame is resent to the ONUs, the ranging time stamp and the churning key with different ABAB and ABAT values are requested. The ABAB instructs the ONUs when its DW count reaches the same value as the ABAB. The ABAT instructs the ONUs when to stop transmission when its DW count reaches the same value as the ABAT. The DW count for the ONUs resets to 0000 when the respective ONU receives and recognizes the start frame delimiter (SFD) from the OLT 100.

In step 2427, each of the ONUs returns a corresponding ONU frame 1100 to the OLT 100, sequentially responding to the OLT 100 with its respective ONU ID (as shown herein and in conjunction with, e.g., FIG. 11). In step 2429, the arrived time for the ONUs is recalculated. The OLT 100 records the values of the DW count at the beginning and end time when each data packet or frame is arrived at the OLT 100. The OLT 100 ensures that the ONU frames are received correctly and error-free. The DW count values facilitate the OLT 100 in ensuring that each ONU frame arrives in the proper transmission sequence. The arrived time is accordingly recalculated, as illustrated in FIG. 17. In step 2431, the time difference between consecutive ONUs is recalculated (as shown herein and in conjunction with, e.g., FIG. 17).

In step 2433, it is determined whether the safety guard time is sufficient. The time difference between each two consecutive ONUs must be greater than or equal to a predetermined safety guard time, e.g., 0030. If it is determined in step 2433 that the safety guard time is insufficient, then the control flow reverts back to step 2401. If it is determined in step 2433 that the safety guard time is sufficient, then the control flow ends.

Referring to FIG. 25 where automatic ranging for a warm PON with cold ONUs according to the invention is exemplarily illustrated, the control flow is directed from step 2500 (as shown herein and in conjunction with, e.g., FIG. 24) to step 2501. In step 2501, transmission of data packets or frames of lower priority is stopped. For an already busy PON, the OLT 100 instructs the ONUs to temporarily suspend transmission of lower-priority data packets or frames for a few mini-seconds.

In step 2503, the offset value for the ABAB is reset (as shown herein and in conjunction with, e.g., FIG. 18). In step 2505, a parameter is input regarding the distance between the OLT 100 and the ONU to be inserted or removed (e.g., ONU E). The parameter is used to determine the safety bandwidth margin for the ABAB in preventing the collision of data packets or frames.

In step 2507, the ABAB and ABAT are rearranged (as shown herein and in conjunction with, e.g., FIG. 19). The OLT 100 rearranges the ABAB and ABAT for each ONU with an offset value (e.g., 3500) for the ONUs already in service with the PON and inserts the automatic ranging measurement packet or frame of ONU E into the OLT frame (as shown herein and in conjunction with, e.g., FIG. 19).

In step 2509, the OLT frame with the new ABAB and ABAT is sent to the ONUs. The OLT 100 waits for a proper time interval and then sends the OLT frame with new ABAB and ABAT to the ONUs which instructs each ONU to transmit ONU frames in a newly rearranged sequence as shown in, e.g., FIG. 21. In step 2511, each of the ONUs, upon receiving the OLT frame, returns an ONU frame (as shown herein and in conjunction with, e.g., FIG. 11) as soon as it recognizes the value of the ABAB as 00,00.

In step 2513, the round trip time for the new ONU inserted into the PON (e.g., ONU E) is calculated, e.g., at 0140 (as shown herein and in conjunction with, e.g., FIG. 22). In step 2515, a new transmission sequence for the ONUs is rearranged (as shown in, e.g., FIG. 20). In step 2517, the time difference between consecutive ONUs is calculated (as shown herein and in conjunction with, e.g., FIG. 22). In step 2519, the time difference is masked and yields a masking result (as shown herein and in conjunction with, e.g., FIG. 22). If it is determined in step 2521 that the masking result is greater than the predetermined value, then the control flow is directed to step 2525. If it is determined in step 2521 that the masking result is not greater than the predetermined value, then the control flow is directed to step 2523.

In step 2523, a time difference value is set to the predetermined value (as shown herein and in conjunction with, e.g., FIG. 22) and the control flow is directed to step 2527. In step 2525, the time difference value is set to the difference of the predetermined value and the masking result (as shown herein and in conjunction with, e.g., FIG. 22). In step 2527, the ABAB and ABAT are accordingly recalculated. The ABAB and ABAT for each of the ONUs are calculated according to the time difference values calculated for each grouping of two consecutive data frames in transmission from the ONUs to the OLT 100 in the PON. Based on the calculations tabulated in FIG. 22, for example, for ONU 1 the ABAB is set to 0000 and the ABAT is accordingly the sum of 0000 and 0700 which is 0700 (0000+0700=0700). Succeeding data frames are separated by the respectively calculated time difference values. For ONU E, the ABAB is set to the sum of 0700 (ABAT for ONU 1) and 0040 (time difference value for ONU E) which is 0740 (0070+0040=0740). The ABAT for ONU E is accordingly the sum of 0740 (ABAB for ONU E) and 0006 which is 0746 (0740+0006=0746). For ONU 3, the ABAB is set to the sum of 0740 (ABAB for ONU E) and 0040 (time difference value for ONU 3) which is 0780 (0740+0040=0780). The ABAT for ONU 3 is accordingly the sum of 0780 (ABAB for ONU 3) and 0900 which is 1080 (0780+0090=1080). For ONU 2, the ABAB is set to the sum of 1080 (ABAT for ONU 3) and 0040 (time difference value for ONU 2) which is 10C0 (1080+0040=10C0). The ABAT for ONU 2 is accordingly the sum of 10C0 (ABAB for ONU 2) and 1040 which is 2100 (10C0+1040=2100). For ONU 4, the ABAB is set to the sum of 2100 (ABAT for ONU 2) and (−0080) (time difference value for ONU 4) which is 2080 (2100+(−0080)=2080). The ABAT for ONU 4 is accordingly the sum of 2080 (ABAB for ONU 4) and 1240 which is 32C0 (2080+1240=32C0).

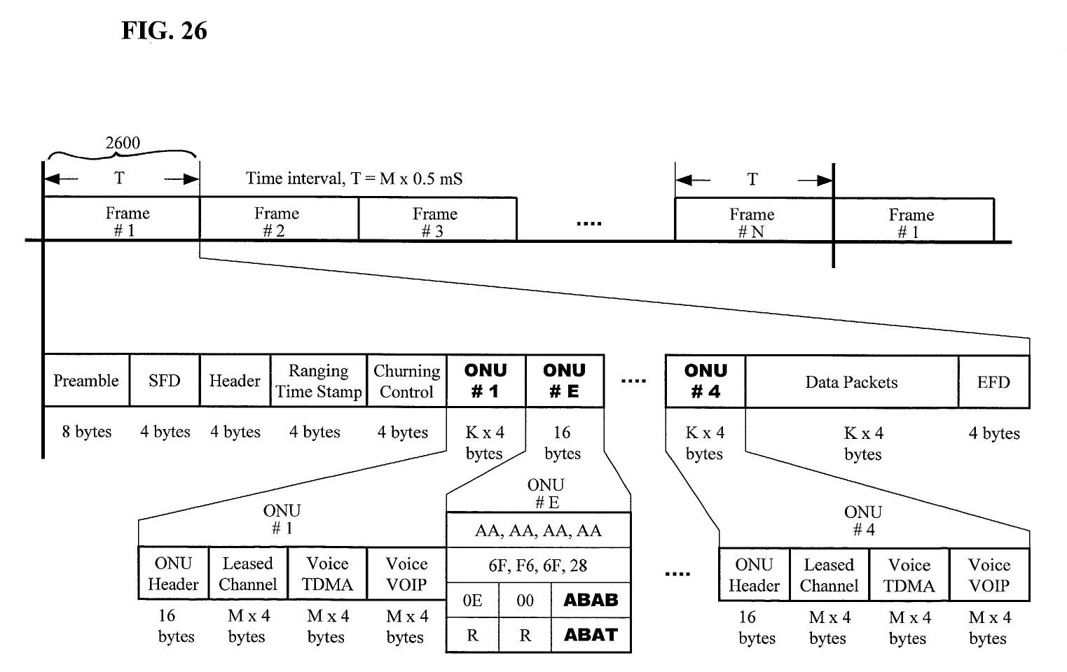

In step 2529, the recalculations in step 2527 are input into the OLT frame which is then resent to the ONUs (e.g., frame 2300 of FIG. 23, or similarly frame 2600 of FIG. 26). As the OLT frame is resent to the ONUs, the ranging time stamp and the churning key with different ABAB and ABAT values are requested. The ABAB instructs the ONUs when its DW count reaches the same value as the ABAB. The ABAT instructs the ONUs when to stop transmission when its DW count reaches the same value as the ABAT. The OLT 100 sends the OLT frame with the newly calculated ABAB and ABAT to instruct the ONUs to transmit data packets or frames in a new transmission sequence.

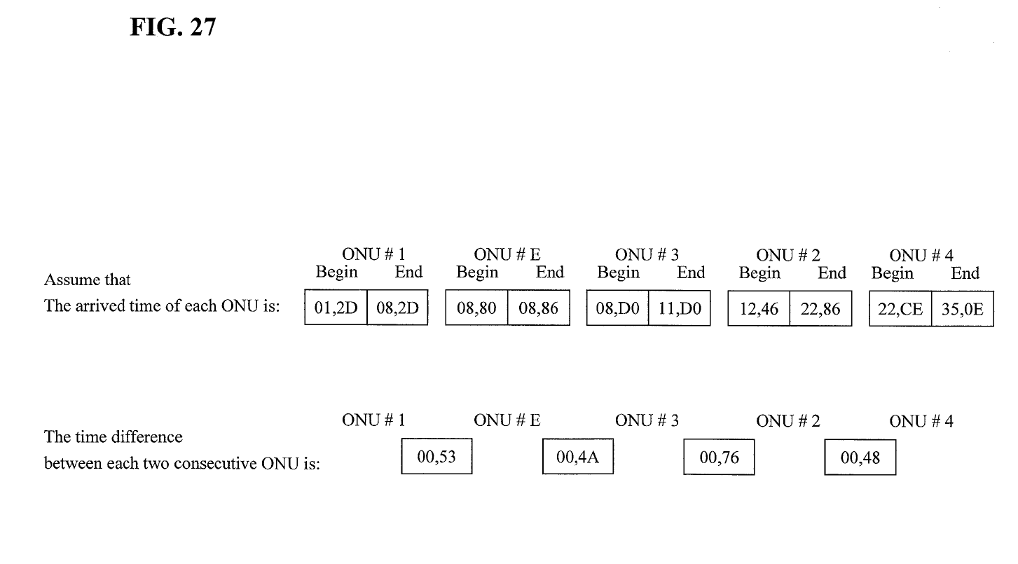

In step 2531, each of the ONUs returns a corresponding ONU frame 1100 to the OLT 100, sequentially responding to the OLT 100 with its respective ONU ID (as shown herein and in conjunction with, e.g., FIG. 11). In step 2533, the arrived time for the ONUs is recalculated. The OLT 100 records the values of the DW count at the beginning and end time when each data packet or frame is arrived at the OLT 100. The DW count values facilitate the OLT 100 in ensuring that each ONU frame arrives in the proper transmission sequence. The arrived time is accordingly recalculated, as illustrated and tabulated in FIG. 27. In step 2535, the time difference between consecutive ONUs is recalculated (as shown herein and in conjunction with, e.g., FIG. 27).

In step 2537, it is determined whether the safety guard time is sufficient. The time difference between each two consecutive ONUs must be greater than or equal to a predetermined safety guard time, e.g., 0030. If it is determined in step 2537 that the safety guard time is insufficient, then the control flow reverts back to step 2501. If it is determined in step 2537 that the safety guard time is sufficient, then the control flow ends.

In addition, the automatic ranging method according to the invention, including the process steps described in conjunction with FIG. 24, can be applied to the transmission of a downstream data frame in accordance with the related U.S. patent application Ser. No. 09/792,309 filed on Feb. 23, 2001 and entitled “IP PACKETIZED FRAME FORMAT IN A PASSIVE OPTICAL NETWORK” as a new ONU is being inserted into the PON, as described herein and, e.g., in conjunction with FIGS. 21, 22 and 23.

With the automatic ranging method and system according to the invention, a PON can advantageously maintain its operation without serious interruption as ONUs are added or removed from the PON. Furthermore, the safety guard time between consecutive data frames in the upstream or downstream transmission is advantageously and appropriately calculated as ONUs are added to or removed from the PON in accordance with the invention.

Although the invention has been particularly shown and described in detail with reference to the preferred embodiments thereof, the embodiments are not intended to be exhaustive or to limit the invention to the precise forms disclosed herein. It will be understood by those skilled in the art that many modifications in form and detail may be made without departing from the spirit and scope of the invention. Similarly, any process steps described herein may be interchangeable with other steps to achieve substantially the same result. All such modifications are intended to be encompassed within the scope of the invention, which is defined by the following claims and their equivalents.

I/We claim:

1. A passive optical network (PON) with automatic ranging comprising;
an optical line terminal (OLT) connected to a plurality of optical network units (ONUs);
a new ONU to be connected to the OLT;
at least one OLT frame sent from the OLT to the ONUs, the OLT frame comprising:
an OLT preamble alerting a particular ONU of the plurality of ONUs of the OLT frame;
an OLT start frame delimiter (SFD) indicating a start of the OLT frame;
an OLT header identifying the OLT;
an OLT ranging time stamp sending a ranging time clock to one of the ONUs;
an OLT churning control for a churning function of the PON;
an ONU number instructing the particular ONU to respond to the OLT with a ranging time stamp and a churning key; and
an OLT end frame delimiter (EFD) indicating an end of the OLT frame.

2. The PON of claim 1 wherein, upon receipt of the OLT frame from the OLT by the particular ONU of the plurality of ONUs, an ONU frame is sent back to the OLT, the ONU frame comprising:
an ONU preamble alerting the OLT of the ONU frame;
an ONU start frame delimiter (SFD) indicating a start of the ONU frame;
an ONU header identifying the particular ONU;
an ONU ranging time stamp responding to the ONU number;
an ONU churning key responding to the ONU number; and
an ONU end frame delimiter (EFD) indicating an end of the ONU frame.

3. The PON of claim 1, the ONU number further comprising:
an ONU number preamble alerting the particular ONU of the ONU number;
a start sub-frame delimiter (SSD) indicating a start of the ONU number;
an ONU ID identifying the particular ONU;
an automatic bandwidth adjustment beginning (ABAB); and
an automatic bandwidth adjustment terminating (ABAT).

4. The PON of claim 1 further comprising an ONU frame for each of the ONUs for returning to the OLT wherein the ONU frame comprises:
an ONU preamble alerting the OLT of the ONU frame;
an ONU start frame delimiter (SFD) indicating a start of the ONU frame;
an ONU header identifying the particular ONU;
an ONU ranging time stamp responding to the ONU number;
an ONU churning key responding to the ONU number; and
an ONU end frame delimiter (EFD) indicating an end of the ONU frame.

5. The PON of claim 4, the ONU number further comprising:
an ONU number preamble alerting the particular ONU of the ONU number;
a start sub-frame delimiter (SSD) indicating a start of the ONU number;
an ONU ID identifying the particular ONU;
an automatic bandwidth adjustment beginning (ABAB); and
an automatic bandwidth adjustment terminating (ABAT).

6. A method for the PON of claim 5 comprising the steps of:
determining if the PON is a cold PON;
if the PON is a cold PON,
(a) inputting the ONU ID into the OLT frame;
(b) sending the OLT frame to each of the ONUs;
(c) returning the respective ONU frame for each of the plurality ONUs to the OLT if the ABAB in the ONU number is recognized;
(d) calculating a round trip time for each of the ONUs in returning their respective ONU frames to the OLT;
(e) arranging the respective ONU frames for the plurality of ONUs in a transmission sequence in accordance with the respective calculated round trip time for each of the ONUs;
(f) calculating a time difference for each group of two consecutive ONU frames for the plurality of ONUs in the transmission sequence;
(g) calculating an arrived time of the respective calculated round trip time for each of the ONUs in the transmission sequence;
(h) masking the time difference for each group of two consecutive ONU frames for the plurality of ONUs in the transmission sequence into a result;
(i) setting a time difference value for each group of two consecutive ONU frames to its respective predetermined value if the masked result in the masking step is less than or equal to the predetermined value;
(j) setting the time difference value to a difference of the predetermined value and the masked result if the masked result in the masking step is greater than the predetermined value;
(k) recalculating the ABAB and ABAT in the ONU number according to the time difference value;
(l) resending the OLT frame to each of the ONUs with the recalculated ABAB and ABAT;
(m) returning the respective ONU frame for each of the plurality ONUs to the OLT in the transmission sequence if the recalculated ABAB in the ONU number is recognized;
(n) recalculating an arrived time of the respective calculated round trip time for each of the ONUs in the transmission sequence, and respective begin time and end time for the arrived time;
(o) recalculating the time difference for each group of two consecutive ONU frames for the plurality of ONUs in the transmission sequence;
(p) determining if the recalculated time difference is greater than or equal to a predetermined safety guard time.

7. The method of claim 6 further comprising the step of repeating the steps (a), (b), (c), (d), (e), (f), (g), (h), (i), (j), (k), (l), (m), (n), (o) and (p) if it is determined in step (p) that the recalculated time difference is not greater than or equal to the predetermined safety guard time.

8. The method of claim 6 further comprising the steps of:
determining if there is more than one new ONU to be connected to the OLT;
if it is determined there is more than one new ONU to be connected to the OLT, repeating steps (a), (b), (c) and (d).

9. The method of claim 6 further comprising the steps of:
starting the returning step (c) if a double word (DW) count reaches the ABAB;
stopping the returning step (c) if the DW count reaches the ABAT;
starting the returning step (m) if the DW count reaches the recalculated ABAB; and
stopping the returning step (m) if the DW count reaches the recalculated ABAT.

10. The method of claim 6 further comprising the steps of:
determining if the PON is a warm PON with cold ONUs;
if the PON is a warm PON with cold ONUs,
(1) stopping transmission of data frames of lower priority;
(2) resetting an offset value for the ABAB;
(3) inputting a parameter for a distance between the new ONU and the OLT;
(4) rearranging the ABAB and the ABAT with the offset value;
(5) sending the OLT frame to each of the ONUs with the rearranged ABAB and ABAT;
(6) returning the respective ONU frame for each of the plurality ONUs to the OLT if the ABAB in the ONU number is recognized;
(7) calculating a round trip time for each of the ONUs, including the new ONU, in returning their respective ONU frames to the OLT;
(8) rearranging the respective ONU frames for the plurality of ONUs, including the new ONU, in a new transmission sequence in accordance with the respective calculated round trip time for each of the ONUs;
(9) calculating a time difference for each group of two consecutive ONU frames for the plurality of ONUs in the new transmission sequence;
(10) calculating an arrived time of the respective calculated round trip time for each of the ONUs in the new transmission sequence;
(11) masking the time difference for each group of two consecutive ONU frames for the plurality of ONUs in the new transmission sequence into a result;
(12) setting a time difference value for each group of two consecutive ONU frames to its respective predetermined value if the masked result in the masking step is less than or equal to the predetermined value;
(13) setting the time difference value to a difference of the predetermined value and the masked result if the masked result in the masking step is greater than the predetermined value;
(14) recalculating the ABAB and ABAT in the ONU number according to the time difference value;
(15) resending the OLT frame to each of the ONUs with the recalculated ABAB and ABAT;
(16) returning the respective ONU frame for each of the plurality ONUs to the OLT in the new transmission sequence if the recalculated ABAB in the ONU number is recognized;
(17) recalculating an arrived time of the respective calculated round trip time for each of the ONUs in the new transmission sequence, and respective begin time and end time for the arrived time;
(18) recalculating the time difference for each group of two consecutive ONU frames for the plurality of ONUs in the new transmission sequence;
(19) determining if the recalculated time difference is greater than or equal to a predetermined safety guard time.

11. The method of claim 10 further comprising the step of repeating the steps (1), (2), (3), (4), (5), (6), (7), (8), (9), (10), (11), (12), (13), (14), (15), (16), (17), (18) and (19) if it is determined in step (19) that the recalculated time difference is not greater than or equal to the predetermined safety guard time.

12. A method for a passive optical network (PON) comprising a plurality of optical network units (ONUs) and an optical line terminal (OLT), the method comprising the steps of:
determining if the PON is a cold PON;
if the PON is a cold PON,
(20) inputting an ONU ID into an OLT frame from the OLT;
(21) sending the OLT frame to each of the ONUs;
(22) returning a respective ONU frame for each of the plurality ONUs to the OLT if an automatic bandwidth adjustment beginning (ABAB) in an ONU number in the respective ONU frame is recognized;
(23) calculating a round trip time for each of the ONUs in returning their respective ONU frames to the OLT;
(24) arranging the respective ONU frames for the plurality of ONUs in a transmission sequence in accordance with the respective calculated round trip time for each of the ONUs;
(25) calculating a time difference for each group of two consecutive ONU frames for the plurality of ONUs in the transmission sequence;
(26) calculating an arrived time of the respective calculated round trip time for each of the ONUs in the transmission sequence;
(27) masking the time difference for each group of two consecutive ONU frames for the plurality of ONUs in the transmission sequence into a result;
(28) setting a time difference value for each group of two consecutive ONU frames to its respective predetermined value if the masked result in the masking step is less than or equal to the predetermined value;
(29) setting the time difference value to a difference of the predetermined value and the masked result if the masked result in the masking step is greater than the predetermined value;
(30) recalculating the ABAB and an automatic bandwidth adjustment terminating (ABAT) in the ONU number according to the time difference value;
(31) resending the OLT frame to each of the ONUs with the recalculated ABAB and ABAT;
(32) returning the respective ONU frame for each of the plurality ONUs to the OLT in the transmission sequence if the recalculated ABAB in the ONU number is recognized;
(33) recalculating an arrived time of the respective calculated round trip time for each of the ONUs in the transmission sequence, and respective begin time and end time for the arrived time;
(34) recalculating the time difference for each group of two consecutive ONU frames for the plurality of ONUs in the transmission sequence;
(35) determining if the recalculated time difference is greater than or equal to a predetermined safety guard time.

13. The method of claim 12 further comprising the step of repeating the steps (20), (21), (22), (23), (24), (25), (26), (27), (28), (29), (30), (31), (32), (33), (34) and (35) if it is determined in step (35) that the recalculated time difference is not greater than or equal to the predetermined safety guard time.

14. The method of claim 12 further comprising the steps of:
determining if there is more than one new ONU to be connected to the OLT;
if it is determined there is more than one new ONU to be connected to the OLT, repeating steps (20), (21), (22) and (23).

15. The method of claim 12 further comprising the steps of:
starting the returning step (22) if a double word (DW) count reaches the ABAB;
stopping the returning step (22) if the DW count reaches the ABAT;
starting the returning step (32) if the DW count reaches the recalculated ABAB; and
stopping the returning step (32) if the DW count reaches the recalculated ABAT.

16. The method of claim 12 further comprising the steps of:
determining if the PON is a warm PON with cold ONUs;
if the PON is a warm PON with cold ONUs,
(36) stopping transmission of data frames of lower priority;
(37) resetting an offset value for the ABAB;
(38) inputting a parameter for a distance between the new ONU and the OLT;
(39) rearranging the ABAB and the ABAT with the offset value;
(40) sending the OLT frame to each of the ONUs with the rearranged ABAB and ABAT;
(41) returning the respective ONU frame for each of the plurality ONUs to the OLT if the ABAB in the ONU number is recognized;
(42) calculating a round trip time for each of the ONUs, including the new ONU, in returning their respective ONU frames to the OLT;
(43) rearranging the respective ONU frames for the plurality of ONUs, including the new ONU, in a new transmission sequence in accordance with the respective calculated round trip time for each of the ONUs;
(44) calculating a time difference for each group of two consecutive ONU frames for the plurality of ONUs in the new transmission sequence;
(45) calculating an arrived time of the respective calculated round trip time for each of the ONUs in the new transmission sequence;
(46) masking the time difference for each group of two consecutive ONU frames for the plurality of ONUs in the new transmission sequence into a result;
(47) setting a time difference value for each group of two consecutive ONU frames to its respective predetermined value if the masked result in the masking step is less than or equal to the predetermined value;
(48) setting the time difference value to a difference of the predetermined value and the masked result if the masked result in the masking step is greater than the predetermined value;
(49) recalculating the ABAB and ABAT in the ONU number according to the time difference value;
(50) resending the OLT frame to each of the ONUs with the recalculated ABAB and ABAT;
(51) returning the respective ONU frame for each of the plurality ONUs to the OLT in the new transmission sequence if the recalculated ABAB in the ONU number is recognized;
(52) recalculating an arrived time of the respective calculated round trip time for each of the ONUs in the new transmission sequence, and respective begin time and end time for the arrived time;
(53) recalculating the time difference for each group of two consecutive ONU frames for the plurality of ONUs in the new transmission sequence;
(54) determining if the recalculated time difference is greater than or equal to a predetermined safety guard time.

17. The method of claim 16 further comprising the step of repeating the steps (36), (37), (38), (39), (40), (41), (42), (43), (44), (45), (46), (47), (48), (49), (50), (51), (52), (53) and (54) if it is determined in step (54) that the recalculated time difference is not greater than or equal to the predetermined safety guard time.
